(19) United States
(12) Patent Application Publication
(10) Pub. No.: US 2025/0151099 A1
(43) Pub. Date: May 8, 2025

(54) TECHNIQUES FOR MANAGING NON-LINEAR DISTORTIONS

(71) Applicant: QUALCOMM Incorporated, San Diego, CA (US)

(72) Inventors: Igor GUTMAN, Hod HaSharon (IL); Junyi LI, Greentown, PA (US); Pushkar Bajirao KULKARNI, San Diego, CA (US); Abdelrahman Mohamed Ahmed Mohamed IBRAHIM, San Diego, CA (US); Joseph Patrick BURKE, Carlsbad, CA (US); Tao LUO, San Diego, CA (US); Juergen CEZANNE, Ocean Township, NJ (US)

(21) Appl. No.: 18/837,158

(22) PCT Filed: Mar. 30, 2023
(86) PCT No.: PCT/US2023/065172

§ 371 Date: Aug. 8, 2024

(30) Foreign Application Priority Data
Apr. 15, 2022 (IL) 292300

(51) Int. Cl. H04W 72/541; H04W 72/0453; H04W 72/20; H04W 72/51

(52) U.S. Cl. CPC H04W 72/541; H04W 72/0453; H04W 72/20; H04W 72/51

(57) ABSTRACT

Methods, systems, and devices for wireless communication are described. A communication device, such as a network entity may determine a set of topologies associated with a non-linear distortion characteristic of a wireless communication at a set of devices (e.g., a user equipment (UE), a base station). For example, a single waveform may have different distortion characteristics on different frequencies. Each of one or more topologies of the set of topologies may include a frequency spectrum mask for the wireless communication. The wireless communication may include a waveform at a first frequency. The frequency spectrum mask associated with the non-linear distortion characteristic of the waveform at the first frequency may be for interference mitigation at a second frequency different than the first frequency. The network entity may transmit first control signaling indicating the set of topologies associated with the non-linear distortion characteristic of the waveform.

### CROSS REFERENCE

The present Application is a 371 national stage filing of International PCT Application No. PCT/US2023/065172 by GUTMAN et al. entitled “TECHNIQUES FOR MANAGING NON-LINEAR DISTORTIONS,” filed Mar. 30, 2023; and claims priority to Israel Patent Application No. 292300 by GUTMAN et al. entitled “TECHNIQUES FOR MANAGING NON-LINEAR DISTORTIONS,” filed Apr. 15, 2022, each of which is assigned to the assignee hereof, and each of which is expressly incorporated by reference in its entirety herein.

### FIELD OF TECHNOLOGY

The following relates to wireless communication, including techniques for managing non-linear distortions.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support techniques for managing non-linear distortions. A communication device, such as a network entity may control non-linear distortion characteristics for wireless communications by one or more other communication devices to manage a network throughput and efficiency. A single waveform may have different distortion characteristics on different frequencies. The network entity may signal to one or more communication devices a set of topologies, which may define restrictions and control non-linear distortion on respective frequency locations for wireless communication at the one or more communication devices. Each topology may also include a set of parameters, for example, a frequency locations, a resolution, and power ratio value (e.g., as a dBc value) and a signal strength value (e.g., as a dBm value) associated with each frequency location, among other examples. By signaling a set of topologies to control a non-linear distortion characteristics at the communication device, the network may experience high throughput, and as result, the communication device may experience low latency and high reliable wireless communications.

A method for wireless communication at a network entity is described. The method may include determining a set of topologies associated with a non-linear distortion characteristic of a wireless communication at a set of devices, each of one or more topologies of the set of topologies including a frequency spectrum mask for the wireless communication, the wireless communication including a waveform at a first frequency, the frequency spectrum mask associated with the non-linear distortion characteristic of the waveform at the first frequency for interference mitigation at a second frequency different than the first frequency and transmitting first control signaling indicating the set of topologies associated with the non-linear distortion characteristic of the waveform.

An apparatus for wireless communication at a network entity is described. The apparatus may a processor, a memory coupled with the processor, wherein the memory comprises instructions executable by the processor to cause the apparatus to determine a set of topologies associated with a non-linear distortion characteristic of a wireless communication at a set of devices, each of one or more topologies of the set of topologies including a frequency spectrum mask for the wireless communication, the wireless communication including a waveform at a first frequency, the frequency spectrum mask associated with the non-linear distortion characteristic of the waveform at the first frequency for interference mitigation at a second frequency different than the first frequency and transmit first control signaling indicating the set of topologies associated with the non-linear distortion characteristic of the waveform.

Another apparatus for wireless communication at a network entity is described. The apparatus may include means for determining a set of topologies associated with a non-linear distortion characteristic of a wireless communication at a set of devices, each of one or more topologies of the set of topologies including a frequency spectrum mask for the wireless communication, the wireless communication including a waveform at a first frequency, the frequency spectrum mask associated with the non-linear distortion characteristic of the waveform at the first frequency for interference mitigation at a second frequency different than the first frequency and means for transmitting first control signaling indicating the set of topologies associated with the non-linear distortion characteristic of the waveform.

A non-transitory computer-readable medium storing code for wireless communication at a network entity is described. The code may include instructions executable by a processor to determine a set of topologies associated with a non-linear distortion characteristic of a wireless communication at a set of devices, each of one or more topologies of the set of topologies including a frequency spectrum mask for the wireless communication, the wireless communication including a waveform at a first frequency, the frequency spectrum mask associated with the non-linear distortion characteristic of the waveform at the first frequency for interference mitigation at a second frequency different than the first frequency and transmit first control signaling indicating the set of topologies associated with the non-linear distortion characteristic of the waveform.

Some examples of the method, apparatuses, and non-transitory computer-readable medium described herein may further include operations, features, means, or instructions for receiving second control signaling indicating a capability to support one or more topologies of the set of topologies associated with the non-linear distortion characteristic of the wireless communication based on the transmitted first control signaling and where the second control signaling includes a radio resource control (RRC) message or a medium access control-control element (MAC-CE).

Some examples of the method, apparatuses, and non-transitory computer-readable medium described herein may further include operations, features, means, or instructions for selecting at least one topology of the set of topologies for use by the set of devices for the wireless communication, based on timing information, network load information, or radio access technology information, or any combination thereof, transmitting second control signaling indicating the selected at least one topology of the set of topologies, and where the second control signaling includes an RRC message or a MAC-CE.

Some examples of the method, apparatuses, and non-transitory computer-readable medium described herein may further include operations, features, means, or instructions for identifying an index value associated with the selected at least one topology of the set of topologies and where the second control signaling includes an indication of the index value associated with the selected at least one topology of the set of topologies.

Some examples of the method, apparatuses, and non-transitory computer-readable medium described herein may further include operations, features, means, or instructions for determining a duration including a set of slots in which the selected at least one topology of the set of topologies may be valid and where the second control signaling includes a first indication of the duration including the set of slots in which the selected at least one topology of the set of topologies may be valid.

Some examples of the method, apparatuses, and non-transitory computer-readable medium described herein may further include operations, features, means, or instructions for determining a beginning slot of the set of slots in which the selected at least one topology of the set of topologies may be valid and where the second control signaling includes a second indication of the beginning slot of the set of slots in which the selected at least one topology of the set of topologies may be valid.

In some examples of the method, apparatuses, and non-transitory computer-readable medium described herein, transmitting the first control signaling may include operations, features, means, or instructions for transmitting an RRC message or a MAC-CE, or both, indicating the set of topologies associated with the non-linear distortion characteristic of the wireless communication.

In some examples of the method, apparatuses, and non-transitory computer-readable medium described herein, at least one topology of the set of topologies includes a baseline topology associated with the non-linear distortion characteristic of the wireless communication, the baseline topology corresponding to a default topology.

Some examples of the method, apparatuses, and non-transitory computer-readable medium described herein may further include operations, features, means, or instructions for broadcasting second control signaling indicating the baseline topology associated with the non-linear distortion characteristic of the wireless communication and where the second control signaling includes a broadcast message including a downlink control information (DCI) or MAC-CE.

Some examples of the method, apparatuses, and non-transitory computer-readable medium described herein may further include operations, features, means, or instructions for identifying an index value associated with the baseline topology associated with the non-linear distortion characteristic of the wireless communication and where the second control signaling includes an indication of the index value associated with the baseline topology.

Some examples of the method, apparatuses, and non-transitory computer-readable medium described herein may further include operations, features, means, or instructions for receiving second control signaling indicating a preferred set of topologies for a second network entity based on the transmitted first control signaling and transmitting third control signaling indicating feedback for the preferred set of topologies, the feedback indicating an acknowledgment or a negative acknowledgment.

Some examples of the method, apparatuses, and non-transitory computer-readable medium described herein may further include operations, features, means, or instructions for receiving the second control signaling, transmitting the third control signaling, or both, occur via a backhaul interface.

Some examples of the method, apparatuses, and non-transitory computer-readable medium described herein may further include operations, features, means, or instructions for receiving second control signaling indicating interference information from at least one device of the set of devices based on the transmitted first control signaling and where transmitting the first control signaling indicating the set of topologies may be based on the received second control signaling indicating the interference information.

Some examples of the method, apparatuses, and non-transitory computer-readable medium described herein may further include operations, features, means, or instructions for receiving second control signaling from at least one device of the set of devices indicating a preferred topology of the set of topologies or at least one topology different from the set of topologies based on the transmitted first control signaling and where the second control signaling including an RRC message, a MAC-CE, uplink control information (UCI), or any combination thereof.

Some examples of the method, apparatuses, and non-transitory computer-readable medium described herein may further include operations, features, means, or instructions for receiving, based on the transmitted first control signaling, second control signaling from at least one device of the set of devices indicating a characteristic associated with at least one topology of the set of topologies used by the at least one device for sidelink communications.

In some examples of the method, apparatuses, and non-transitory computer-readable medium described herein, each of one or more topologies of the set of topologies includes a frequency location value associated with the wireless communication, a resolution value associated with the wireless communication, a power ratio value associated with the wireless communication, a signal strength value associated with the wireless communication, or an error vector magnitude value associated with the wireless communication, or any combination thereof.

In some examples of the method, apparatuses, and non-transitory computer-readable medium described herein, the set of devices includes a UE, a base station, an integrated access and backhaul (IAB) node, or any combination thereof.

A method for wireless communication at a device is described. The method may include receiving, from a network entity, first control signaling indicating a set of topologies associated with a non-linear distortion characteristic of the wireless communication at the device, each of one or more topologies of the set of topologies including a frequency spectrum mask for the wireless communication, the wireless communication including a waveform at a first frequency, the frequency spectrum mask associated with the non-linear distortion characteristic of the waveform at the first frequency for interference mitigation at a second frequency different from the first frequency and controlling the non-linear distortion characteristic associated with the wireless communication based on the received first control signaling indicating the set of topologies.

An apparatus for wireless communication at a device is described. The apparatus may include a processor, a memory coupled with the processor, wherein the memory comprises instructions executable by the processor to cause the apparatus to: receive, from a network entity, first control signaling indicating a set of topologies associated with a non-linear distortion characteristic of the wireless communication at the device, each of one or more topologies of the set of topologies including a frequency spectrum mask for the wireless communication, the wireless communication including a waveform at a first frequency, the frequency spectrum mask associated with the non-linear distortion characteristic of the waveform at the first frequency for interference mitigation at a second frequency different from the first frequency and control the non-linear distortion characteristic associated with the wireless communication based on the received first control signaling indicating the set of topologies.

Another apparatus for wireless communication at a device is described. The apparatus may include means for receiving, from a network entity, first control signaling indicating a set of topologies associated with a non-linear distortion characteristic of the wireless communication at the device, each of one or more topologies of the set of topologies including a frequency spectrum mask for the wireless communication, the wireless communication including a waveform at a first frequency, the frequency spectrum mask associated with the non-linear distortion characteristic of the waveform at the first frequency for interference mitigation at a second frequency different from the first frequency and means for controlling the non-linear distortion characteristic associated with the wireless communication based on the received first control signaling indicating the set of topologies.

A non-transitory computer-readable medium storing code for wireless communication at a device is described. The code may include instructions executable by a processor to receive, from a network entity, first control signaling indicating a set of topologies associated with a non-linear distortion characteristic of the wireless communication at the device, each of one or more topologies of the set of topologies including a frequency spectrum mask for the wireless communication, the wireless communication including a waveform at a first frequency, the frequency spectrum mask associated with the non-linear distortion characteristic of the waveform at the first frequency for interference mitigation at a second frequency different from the first frequency and control the non-linear distortion characteristic associated with the wireless communication based on the received first control signaling indicating the set of topologies.

Some examples of the method, apparatuses, and non-transitory computer-readable medium described herein may further include operations, features, means, or instructions for transmitting second control signaling indicating a capability to support one or more topologies of the set of topologies based on the received first control signaling and where the second control signaling includes an RRC message or a MAC-CE.

Some examples of the method, apparatuses, and non-transitory computer-readable medium described herein may further include operations, features, means, or instructions for receiving second control signaling indicating a selected at least one topology of the set of topologies, by the network entity, associated with the non-linear distortion characteristic of the wireless communication and where the second control signaling includes an RRC message or a MAC-CE.

Some examples of the method, apparatuses, and non-transitory computer-readable medium described herein may further include operations, features, means, or instructions for identifying the selected at least one topology of the set of topologies associated with the non-linear distortion characteristic of the wireless communication based on an indication of an index value, associated with the selected at least one topology of the set of topologies, received in the second control signaling.

Some examples of the method, apparatuses, and non-transitory computer-readable medium described herein may further include operations, features, means, or instructions for identifying a duration including a set of slots in which the selected at least one topology of the set of topologies may be valid based on a first indication of the duration including the set of slots in which the selected at least one topology of the set of topologies may be valid, received in the second control signaling.

Some examples of the method, apparatuses, and non-transitory computer-readable medium described herein may further include operations, features, means, or instructions for identifying a beginning slot of the set of slots in which the selected at least one topology of the set of topologies may be valid based on a second indication of the beginning slot of the set of slots in which the selected at least one topology of the set of topologies may be valid, received in the second control signaling.

In some examples of the method, apparatuses, and non-transitory computer-

readable medium described herein, receiving the first control signaling may include operations, features, means, or instructions for receiving an RRC message or a MAC-CE, or both, indicating the set of topologies associated with the non-linear distortion characteristic of the wireless communication.

In some examples of the method, apparatuses, and non-transitory computer-readable medium described herein, at least one topology of the set of topologies includes a baseline topology associated with the non-linear distortion characteristic of the wireless communication, the baseline topology corresponding to a default topology.

Some examples of the method, apparatuses, and non-transitory computer-readable medium described herein may further include operations, features, means, or instructions for receiving second control signaling indicating the baseline topology and where the second control signaling includes a broadcast message including a DCI or MAC-CE.

Some examples of the method, apparatuses, and non-transitory computer-readable medium described herein may further include operations, features, means, or instructions for identifying the baseline topology associated with the non-linear distortion characteristic of the wireless communication based on an indication of an index value associated with the baseline topology received in the second control signaling.

In some examples of the method, apparatuses, and non-transitory computer-readable medium described herein, the device includes a UE, a base station, an IAB node, or any combination thereof.

### BRIEF DESCRIPTION OF THE DRAWINGS

FIGS. 1 and 2 illustrate examples of wireless communications systems that support techniques for managing non-linear distortions in accordance with one or more aspects of the present disclosure.

FIGS. 3A and 3B illustrates example of topologies that support techniques for managing non-linear distortions in accordance with one or more aspects of the present disclosure.

FIG. 4 illustrates an example of a wireless communications system that supports techniques for managing non-linear distortions in accordance with one or more aspects of the present disclosure.

FIG. 5 illustrates an example of a process flow that supports techniques for managing non-linear distortions in accordance with one or more aspects of the present disclosure.

FIGS. 6 and 7 show block diagrams of devices that support techniques for managing non-linear distortions in accordance with one or more aspects of the present disclosure.

FIG. 8 shows a block diagram of a communications manager that supports techniques for managing non-linear distortions in accordance with one or more aspects of the present disclosure.

FIG. 9 shows a diagram of a system including a device that supports techniques for managing non-linear distortions in accordance with one or more aspects of the present disclosure.

FIGS. 10 and 11 show block diagrams of devices that support techniques for managing non-linear distortions in accordance with one or more aspects of the present disclosure.

FIG. 12 shows a block diagram of a communications manager that supports techniques for managing non-linear distortions in accordance with one or more aspects of the present disclosure.

FIG. 13 shows a diagram of a system including a device that supports techniques for managing non-linear distortions in accordance with one or more aspects of the present disclosure.

FIGS. 14 and 15 show flowcharts illustrating methods that support techniques for managing non-linear distortions in accordance with one or more aspects of the present disclosure.

### DETAILED DESCRIPTION

A wireless communications system may include a communication device, such as a UE or a network entity (e.g., an eNodeB (eNB), a next-generation NodeB or a giga-NodeB, either of which may be referred to as a gNB, or some other base station), that support wireless communications over one or multiple radio access technologies. Examples of radio access technologies include 4G systems, such as LTE systems, and 5G systems, which may be referred to as NR systems. The wireless communications may include uplink transmission, uplink reception, downlink transmission, or downlink reception, sidelink transmission, sidelink reception, or a combination thereof. A communication device may be configured with various circuitry to support wireless communications. In some cases, this various circuitry may include non-linear circuit elements, such as a power amplifier. A power amplifier may have a limited linear dynamic range (e.g., a difference between the communication device's maximum input power and a minimum measurable power) and, as a result, may distort the wireless communication (e.g., signals) due to high peak to average power ratio (PAPR).

In some cases, to avoid the distortion of the wireless communication, the communication device may be configured to support output power back-off operations (e.g., reducing a power level for the power amplifier). Output power back-off may be defined as a power level at an output of the power amplifier relative to a maximum output level possible using the power amplifier. However, the higher an output power back-off value, the lower the efficiency of the power amplifier. Some techniques for decreasing or mitigating distortion of wireless communication (e.g., signals) are suboptimal and lack in efficiency, performance, resource cost, and may limit the dynamic range of the wireless communication (e.g., signals).

Various aspects of the present disclosure relate to enabling the network to control non-linear distortion characteristics for one or more communication devices (e.g., a UE, a base station, an integrated access and backhaul (IAB) node, or any combination thereof), and manage a network throughput and efficiency. A single waveform may have different distortion characteristics on different frequencies. The network may signal to one or more communication devices a set of topologies (also referred to as configurations). Each topology may define restrictions on the non-linear distortion characteristics for the one or more communication devices. Each topology may also include a set of parameters including: a frequency location, a resolution (e.g., in megahertz (MHz), channel bandwidth, etc.), a power ratio value (e.g., a dBc values), a signal strength values, among other examples. In some implementations, the communication device may provide capability signaling to the network to indicate the communication device's capability for supporting one or more topologies of set of topologies.

The signaling between the network and the communication device for the set of topologies may include semi-static signaling, such as radio resource control messaging. Alternatively, the signaling may include dynamic signaling, such as downlink control information (DCI), uplink control information (UCI), medium access control-control element (MAC-CE), or any combination thereof. The capability signaling from the communication device to the network may similarly include semi-static signaling, dynamic signaling, or both. In some other implementations, the network and the communication device may negotiate (e.g., via a set of handshake messages) a preferred topology of the set of topologies. By signaling a set of topologies to control a non-linear distortion characteristics at the communication device, the network may experience high throughput, and as result, the communication device may experience low latency and high reliable wireless communications.

Aspects of the disclosure are initially described in the context of wireless communications systems. Aspects of the disclosure are further illustrated by and described with reference to apparatus diagrams, system diagrams, and flowcharts that relate to techniques for managing non-linear distortions.

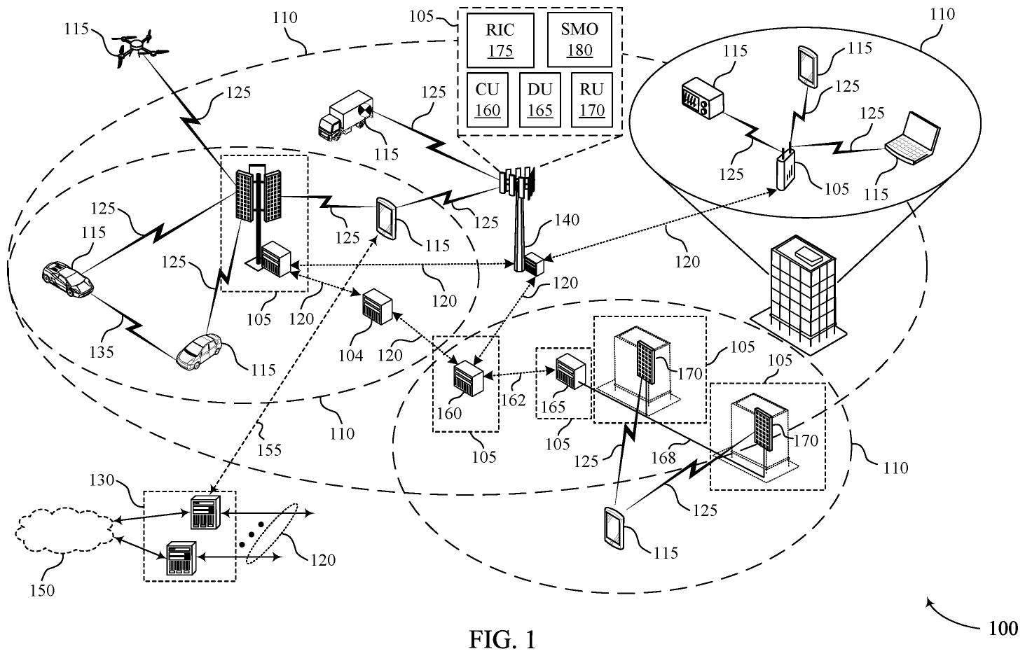

FIG. 1 illustrates an example of a wireless communications system 100 that supports techniques for managing non-linear distortions in accordance with one or more aspects of the present disclosure. The wireless communications system 100 may include one or more network entities 105, one or more UEs 115, and a core network 130. In some examples, the wireless communications system 100 may be an LTE network, an LTE-A network, an LTE-A Pro network, an NR network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or another interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 over an interface (e.g., a backhaul link). IAB donor and IAB nodes 104 may communicate over an F1 interface according to a protocol that defines signaling messages (e.g., an F1 AP protocol). Additionally, or alternatively, the CU 160 may communicate with the core network over an interface, which may be an example of a portion of backhaul link, and may communicate with other CUs 160 (e.g., a CU 160 associated with an alternative IAB donor) over an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104 and may directly signal transmissions to a UE 115. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support techniques for managing non-linear distortions as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving.” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be positioned according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology)

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum, and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 MHz). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support concurrent communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., over a carrier) and may be associated with an identifier for distinguishing neighboring cells (e.g., a physical cell identifier (PCID), a virtual cell identifier (VCID), or others). In some examples, a cell may also refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications over the one or more cells using one or multiple component carriers.

In some examples, a carrier may support multiple cells, and different cells may be configured according to different protocol types (e.g., MTC, narrow band IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating over a limited bandwidth (e.g., according to narrow band communications), or a combination of these techniques. For example, some UEs 115 may be configured for operation using a narrow band protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below: 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a network entity 105 or a core network 130 supporting radio bearers for user plane data. At the PHY layer, transport channels may be mapped to physical channels.

The UEs 115 and the network entities 105 may support retransmissions of data to increase the likelihood that data is received successfully. Hybrid automatic repeat request (HARQ) feedback is one technique for increasing the likelihood that data is received correctly over a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In some other examples, the device may provide HARQ feedback in a subsequent slot, or according to some other time interval.

In some cases, various factors, for example, such as efficiency use of resources including radiated power by a network entity 105, a base station 140, or a UE 115, or any combination thereof may impact performance of the wireless communications system 100. The network entity 105, the base station 140, or the UE 115, or any combination thereof, may be equipped with various circuity, including non-linear circuit elements, such as power amplifiers that may have a limited linear dynamic range. Due to the limited dynamic range of these power amplifiers and high PAPR, wireless communication (e.g., signal transmissions) in the wireless communications system 100 may be distorted. The non-linear distortions may be classified as in-band distortion (IBD), which impact the communication link (e.g., a communication link 120, a communication link 125, or a communication link 135 performance in sense of mutual information or/and EVM, and out-band distortion (OBD), which may define the amount of adjacent channel interference (ACI) or in band emissions (IBE). The ACI may indicate how much an adjacent channel is polluted (e.g., congested) by a transmission, while the IBE is similarly to ACI, but in the same channel. In order to avoid the distortions, output power back-off may be supported, however the output power back-off comes with a cost. The higher the output power back-off, the less power amplifier power efficiency the network entity 105, the base station 140, or the UE 115, or any combination thereof experience. As such, less power is provided to a channel, while more power is dissipated as heat.

In some other cases, a network entity 105, a base station 140, or a UE 115, or any combination thereof may support crest factor reduction (CFR) and digital pre-distortion (DPD) techniques to improve wireless communication quality and coverage while reducing the wireless communications system 100 operating costs. For example, the CFR techniques may reduce a dynamic range of wireless communication (e.g., signals), while the DPD techniques may linearize a power amplifier response. As a result, the output power back-off is reduced to be as low as possible, and the power amplifier efficiency is improved. Some DPD techniques may be limited to a level of the dynamic range of the wireless communication (e.g., signals), as these DPD techniques might be unable to correct clipping of the wireless communication (e.g., signals). Therefore, a network entity 105, a base station 140, or a UE 115, or any combination thereof may be limited to the CFR ability to reduce the PAPR. Some DPD techniques may have additional requirements (e.g., a single power amplifier for single DPD engine in mmW model mismatch, etc.). In some other cases, some DPD techniques may result in distortion-less wireless communication, but consume resources (e.g., bandwidth, power). In other cases, some DPD techniques may result in signification computational resources, while other DPD techniques (e.g., iterative clip and filtering ICF) introduce distortion to the inband (e.g., EVM) and/or outband (e.g., ACLR) or any other combination.

In other cases, the wireless communications system 100 may support sub-band interference cancelation (SBIC) that may control a location in frequency where a non-linear distortion is concentrated. In some examples, the SBIC may reduce inband EVM. In some examples, the SBIC may reduce inband EVM on a respective component carrier. In some examples, the SBIC may reduce adjacent out of band. In some examples, the SBIC may reduce single side out of band with EVM. In some other examples, the SBIC may reduce single side out of band without EVM. In some examples, the SBIC may reduce a respective portion in frequency.

In some examples, a factor that may impact non-linear distortions restrictions include full duplex deployment. In some examples, direct leakage due to full duplex deployment from a transmitter to a receiver (e.g., direct self-interference). In some other examples, a factor that may impact non-linear distortions restrictions include edge of a radio frequency spectrum allocated to a particular operator. In other examples, a factor that may impact non-linear distortions restrictions include regions of a radio frequency spectrum that may have more emission requirements.

In the wireless communications system 100, a network entity 105 may support topology signaling to one or more devices in the wireless communications system 100 in accordance with aspects of the present disclosure. The network entity 105 may determine multiple topologies for controlling non-linear distortion characteristics of the one or more devices (e.g., a UE 115, a base station 140, a network entity 105, an integrated access and backhaul (IAB) node, or any combination thereof). The network entity 105 may transmit using control signaling (e.g., RRC messaging). Alternatively, the signaling may include dynamic signaling, such as DCI, UCI, MAC-CE, or any combination thereof. In some implementation, one or more of the devices may provide capability signaling to the network entity 105 to indicate the device's capability for supporting one or more topologies. The capability signaling from the device to the network may similarly include semi-static signaling, dynamic signaling, or both. In some other implementations, the network and the device may negotiate (e.g., via a set of handshake messages) a preferred topology of the set of topologies. By signaling a set of topologies to control a non-linear distortion characteristics at a device, the network entity 105 may experience high throughput, and as result, the device (e.g., a UE 115) may experience low latency and high reliable wireless communications.

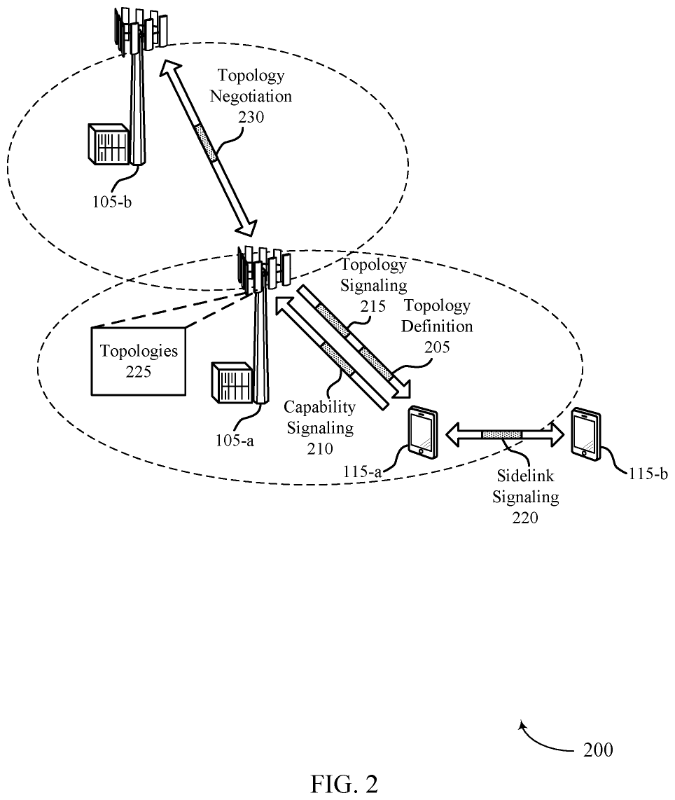

FIG. 2 illustrates an example of a wireless communications system 200 that supports techniques for managing non-linear distortions in accordance with one or more aspects of the present disclosure. The wireless communications system 200 may implement or be implemented by aspects of the wireless communications system 100 as described in FIG. 1. For example, the wireless communications system 200 may include a network entity 105-a, a network entity 105-b, a UE 115-a, and a UE 115-b, which may be examples of network entities 105 and UEs 115 as described with reference to FIG. 1. In some examples, the wireless communications system 200 may support multiple radio access technologies including 4G systems such as LTE systems, LTE-A systems, or LTE-A Pro systems, and 5G systems which may be referred to as NR systems. The wireless communications system 200 may support power saving, and, in some examples, may promote high reliability and low latency wireless communications.

One or more of the network entity 105-a, the network entity 105-b, the UE 115-a, or the UE 115-b, or any combination thereof, may be equipped with multiple antennas, which may be used to employ techniques as described with reference to FIG. 1. The antennas of one or more of the network entity 105-a, the network entity 105-b, the UE 115-a, or the UE 115-b, or any combination thereof, may be located within one or more antenna arrays or antenna panels, which may support operations as described herein. The network entity 105-a, the network entity 105-b, or both, may have an antenna array with a number of rows and columns of antenna ports that the network entity 105-a, the network entity 105-b, or both may use to support wireless communications with the UE 115-a, the UE 115-b, or both. Likewise, the UE 115-a, the UE 115-b, or both may have one or more antenna arrays that may support various operations as described herein. Additionally or alternatively, the UE 115-a, the UE 115-b, or both may have an antenna array with a number of rows and columns of antenna ports that the UE 115-a, the UE 115-b, or both may use to support wireless communications with the network entity 105-a, the network entity 105-b, or both.

One or more antennas or antenna arrays of one or more of the network entity 105-a, the network entity 105-b, the UE 115-a, or the UE 115-b, or any combination thereof may be part of a transmit chain, a receiver chain, or both. A transmit chain may refer to a number of antennas including other circuit elements, which may include amplifiers, filters, mixers, attenuators, and detectors that are configured for transmitting signals (e.g., control information, data). A receiver chain may refer to a number of antennas including other circuit elements, which may include amplifiers, filters, mixers, attenuators, and detectors that are configured for receiving signals (e.g., control information, data).

In some cases, one or more of the network entity 105-a, the network entity 105-b, the UE 115-a, or the UE 115-b, or any combination thereof may be configured with various circuitry to support wireless communications as described herein. In some cases, this various circuitry may include non-linear circuit elements, such as a power amplifier. A power amplifier may have a limited linear dynamic range (e.g., a difference between the device's maximum input power and a minimum measurable power) and, as a result, may distort the wireless communication (e.g., signals) due to high PAPR. In some cases, to avoid the distortion of the wireless communication, one or more of the network entity 105-a, the network entity 105-b, the UE 115-a, or the UE 115-b, or any combination thereof may be configured to support output power back-off operations (e.g., reducing a power level for the power amplifier). Output power back-off may be defined as a power level at an output of the power amplifier relative to a maximum output level possible using the power amplifier. However, the higher an output power back-off value, the lower the efficiency of the power amplifier. Some techniques for decreasing or mitigating distortion of wireless communication (e.g., signals) are suboptimal and lack in efficiency, performance, resource cost, and may limit the dynamic range of the wireless communication (e.g., signals).

In the example of FIG. 2, a respective network entity 105 may control non-linear distortion characteristics for a respective UE 115 and manage a network throughput and efficiency. The respective network entity 105 may signal to the respective UE 115 a set of topologies 225 (also referred to as configurations). Each topology may define restrictions on the non-linear distortion characteristics for the respective UE 115. Each topology may also include a set of parameters including: a frequency location, a resolution, a power ratio value (e.g., a dBc values), a signal strength values (e.g., a dBm value if the dBc value is insufficient), among other examples. In some implementations, the respective UE 115 may provide capability signaling to the respective network entity 105 to indicate the capability for supporting one or more topologies of set of topologies 225.

The signaling between the respective network entity 105 and the respective UE 115 for the set of topologies 225 may include semi-static signaling, such as RRC messaging. Alternatively, the signaling may include dynamic signaling, such as DCI, uplink control information (UCI), MAC-CE, or any combination thereof. The capability signaling from the respective UE 115 to the respective network entity 105 may similarly include semi-static signaling, dynamic signaling, or both. In some other implementations, the respective network entity 105 and the respective UE 115 may negotiate (e.g., via a set of handshake messages) a preferred topology of the set of topologies 225. By signaling a set of topologies to control a non-linear distortion characteristics at a respective UE 115, the respective network entity 105 may experience high throughput, and as result, the respective UE 115 may experience low latency and high reliable wireless communications.

In the example of FIG. 2, the network entity 105-a may signal the set of topologies 225 via a topology signaling 215 to one or more devices, for example, the UE 115-a. Each of one or more topologies of the set of topologies 225 may correspond to an index, which may be transmitted alongside with the set of topologies 225 in a topology definition 205. The topology definition 205 may be transmitted using, for example, a MAC-CE, or an RRC message. The topology definition 205 may be signaled in real time as the topologies 225 may change in real time due to environmental conditions. For example, the topologies 225 may be updated depending on the time of day, the load on the network, the enablement of other technologies, and negotiations of the network entity 105-a with other parts of the network, among other factors.

In some cases, the network entity 105-a may define a baseline, or default, topology 225 in the topology definition 205, and an index associated with the default topology 225. The baseline topology 225 may correspond to default restrictions for non-linear characteristics, which may be defined for the wireless communications system 100, a group of devices, or a single device. The network entity 105-a may then broadcast a reset signal to one or more devices. The reset signal may indicate to the devices to return to the default topology 225 signaled in the topology definition 205. The reset signal may involve broadcasting the index associated with the baseline topology 225. The reset signal may be transmitted using a DCI, or a MAC-CE, for example.

A device, such as UE 115-a, may provide capability signaling 210 to the network entity 105-a. The capability signaling may be in response to the topology signaling 215 and may involve indicating the ability of UE 115-a to support one or more specific topologies 225 from the set of topologies 225 received in the topology definition 205. In some examples, the capability signaling 210 may be transmitted using a MAC-CE or an RRC message. The network entity 105-a may signal to a device, such as UE 115-a to enable respective topologies 225 from the set of topologies 225 using topology signaling 215. The topology signaling 215 may include a topology index associated with a respective topology 225, dynamics indicating the time duration the topology 225 is valid for (e.g., in number of slots, or in some cases, indefinitely), and the start time for the topology 225. The topology signaling 215 may be transmitted using DCI or MAC-CE, for example.

In some examples, the network entity 105-a may negotiate a topology with other devices such as the network entity 105-b. The topology negotiation 230 may be aimed at improving the power efficiency of the network and may evaluate the possible tradeoffs between error vector magnitude (EVM), out-of-band (OOB), and other constraints in negotiations. The topology negotiation 230 may include an exchange of topology descriptions, proposals of new topologies 225, responses to previous proposals, or any combination thereof. In some examples, the topology negotiation 230 may be signaled in an Xn interface and may occur between two base stations 140 (e.g., two gNbs).

In some cases, the UE 115-a may be configured to support a sidelink communications, which may enable autonomous UE operation. The UE 115-a may be able to sense and select resources for sidelink based on the network configuration, such as the topologies 225 received from the network entity 105-a via topology signaling 215. The UE 115-a may broadcast the characteristics of a topology 225 being used to another UE 115-b via sidelink signaling 220. The topology 225 described in the sidelink signaling 215 may be a topology defined by the network entity 105-a in the topology definition 205. Alternatively, the UE 115-a may create a custom topology 225, and transmit the custom characteristics in the sidelink signaling 220 to UE 115-b.

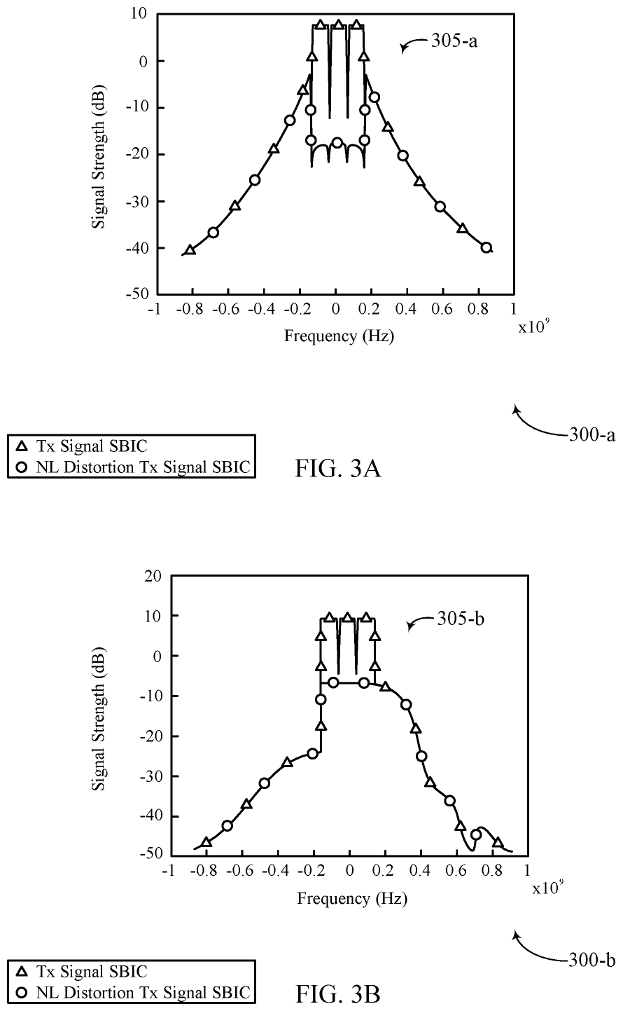

FIG. 3A illustrates an example of a topology 300-a that supports techniques for managing non-linear distortions in accordance with one or more aspects of the present disclosure. The topology 300-a may implement or be implemented by aspects of the wireless communications systems 100 and 200 as described with reference to FIGS. 1 and 2, respectively. For example, the topology 300-a may be implemented by a network entity 105 and a UE 115, which may be an example of a network entity 105 and a UE 115 as described with reference to FIGS. 1 and 2, respectively. The topology 300-a may be associated with a non-linear distortion characteristic of a waveform 305-a (e.g., wireless communication). The topology 300-a may include a frequency spectrum mask for the waveform 305-a, which may support interference mitigation at other frequencies associated with the waveform 305-a, or with other waveforms (e.g., other wireless communications). A network entity 105 or a UE 115, or both, may determine the topology 300-a based on a SBIC to concentrate the non-linear distortion characteristic of the waveform 305-a into respective locations in a frequency domain.

In some examples, the respective locations in the frequency domain selected to concentrate the non-linear distortion characteristic of the waveform 305-a may be selected to reduce an in-band EVM, such as an in-band EVM on a respective component carrier (CC), on an adjacent OOB, on single-side OOB with EVM, on single-side OOB without EVM, or on a respective portion in the frequency domain in which it may be desirable to reduce the non-linear distortion characteristic. The topology 300-a may relate a signal strength of a power amplifier of network entity 105 or a UE 115, or both with and without controlling the non-linear distortion characteristic. In some cases, the topology 300-a may reduce the in-band EVM by concentrating the non-linear distortion characteristic in the portions around a respective frequency band. This may result in improvements to in-band CCs while the non-linear distortion characteristic may be focused on OOB portions. In some other cases, the topology 300-a may reduce an interference on single side OOB without EVM.

FIG. 3B illustrates an example of a topology 300-b that supports techniques for managing non-linear distortions in accordance with one or more aspects of the present disclosure. The topology 300-b may implement or be implemented by aspects of the wireless communications systems 100 and 200 as described with reference to FIGS. 1 and 2, respectively. For example, the topology 300-b may be implemented by a network entity 105 and a UE 115, which may be an example of a network entity 105 and a UE 115 as described with reference to FIGS. 1 and 2, respectively. The topology 300-b may be associated with a non-linear distortion characteristic of a waveform 305-b (e.g., wireless communication). The topology 300-b may include a frequency spectrum mask for the waveform 305-b, which may support interference mitigation at other frequencies associated with the waveform 305-b, or with other waveforms (e.g., other wireless communications). A network entity 105 or a UE 115, or both, may determine the topology 300-b based on a SBIC to concentrate the non-linear distortion characteristic of the waveform 305-b into respective locations in a frequency domain.

In some examples, the respective locations in the frequency domain selected to concentrate the non-linear distortion characteristic of the waveform 305-b may be selected to reduce an in-band EVM, such as an in-band EVM on a respective CC, on an adjacent OOB, on single-side OOB with EVM, on single-side OOB without EVM, or on a respective portion in the frequency domain in which it may be desirable to reduce the non-linear distortion characteristic. The topology 300-b may relate a signal strength of a power amplifier of network entity 105 or a UE 115, or both with and without controlling the non-linear distortion characteristic. In some cases, the topology 300-b may reduce the in-band EVM by concentrating the non-linear distortion characteristic in the portions around a respective frequency band. This may result in improvements to in-band CCs while the non-linear distortion characteristic may be focused on OOB portions. In some other cases, the topology 300-b may reduce an interference on single side OOB without EVM.

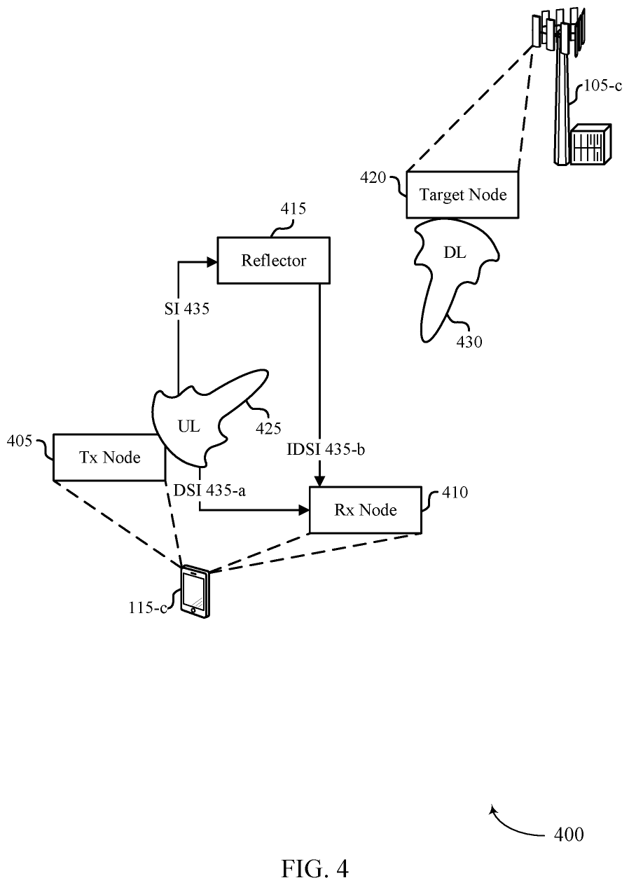

FIG. 4 illustrates an example of a wireless communications system 400 that supports techniques for managing non-linear distortions in accordance with one or more aspects of the present disclosure. The wireless communications system 400 may implement or be implemented by aspects of the wireless communications system 100 or the wireless communications system 200 as described in FIGS. 1 and 2, respectively. For example, the wireless communications system 400 may include a network entity 105-c and a UE 115-c, which may be examples of a network entity 105 and a UE 115 as described with reference to FIGS. 1 and 2, respectively. In some examples, the wireless communications system 400 may support multiple radio access technologies including 4G systems such as LTE systems, LTE-A systems, or LTE-A Pro systems, and 5G systems which may be referred to as NR systems. The wireless communications system 400 may support power saving, and, in some examples, may promote high reliability and low latency wireless communications.

In the example of FIG. 4, the network entity 105-c, the UE 115-c, or both, may be equipped with multiple antennas which may be used to employ techniques as described with reference to FIG. 1. The antennas of the network entity 105-c or the UE 115-c, or both, may be located within one or more antenna arrays or antenna panels, which may support operations as described herein. The network entity 105-c may have an antenna array with a number of rows and columns of antenna ports that the network entity 105-c may use to support wireless communications with the UE 115-c. Likewise, the UE 115-c may have one or more antenna arrays that may support various operations as described herein. Additionally or alternatively, the UE 115-c may have an antenna array with a number of rows and columns of antenna ports that the UE 115-c may use to support wireless communications with the network entity 105-c.

One or more antennas or antenna arrays may be part of a transmit chain, a receiver chain, or both. A transmit chain may refer to a number of antennas including other circuit elements, which may include amplifiers, filters, mixers, attenuators, and detectors that are configured for transmitting signals (e.g., control information, data). A receiver chain may refer to a number of antennas including other circuit elements, which may include amplifiers, filters, mixers, attenuators, and detectors that are configured for receiving signals (e.g., control information, data).

In some cases, the UE 115-c may support full duplex operations, in which the UE 115-c may simultaneously transmit signaling (e.g., uplink, sidelink) and receive signaling (e.g., downlink, sidelink). In some cases, when implementing full duplex operations, the UE 115-c may experience self-interference (SI) 435. A transmission node 405 associated with the UE 115-c may be an antenna array or an antenna panel to support uplink transmission 425 to a target node 420 associated with the network entity 105-c. Likewise, a reception node 410 associated with the UE 115-c may be an antenna array or an antenna panel to support reception of a downlink transmission 430 from the target node 420 associated with the network entity 105-c. In some cases, due to the transmission of the uplink transmission 425 and simultaneously the reception of the downlink transmission 430, the UE 115-c may experience direct self-interference (DSI) 435-a. In some other cases, the uplink transmission 425 may reflect back to the UE 115-c, as a result of a reflector 415 (e.g., an object or other device, such as a reconfigurable intelligent surfaces (RIS)). The reflection of the uplink transmission 425 towards the UE 115-c may cause indirect self-interference (IDSI) 435-b at the UE 115-c.

In some cases, the UE 115-c may detect the self-interference 435, while the network entity 105-c may not be aware of the self-interference 435 at the UE 115-c. In some examples, the UE 115-c may be configured to transmit (e.g., output), and the network entity 105-c may receive (e.g., obtain), control signaling indicating a topology to mitigate the interference (e.g., the self-interference 435, the DSI 435-d, or the IDSI 435-b, or any combination thereof) as described with reference to FIG. 2. In some examples, the UE 115-c may recommend a topology to the network entity 105-c to mitigate the interference (e.g., the self-interference 435, the DSI 435-d, or the IDSI 435-b, or any combination thereof) from a set of topologies received in a topology signaling 215 as described with reference to FIG. 2. In other examples, the UE 115-c may recommend a new, or custom, topology to the network entity 105-c. In some examples, the control signaling may include an RRC message, a MAC-CE, an UCI (e.g., carried on a PUCCH), or other uplink information (e.g., carried on PUSCH). Based on the signaling and selection of a topology, the UE 115-c may mitigate the interference (e.g., the self-interference 435, the DSI 435-d, or the IDSI 435-b, or any combination thereof) experienced at the UE 115-c that may also result in higher reliability for the wireless communications.

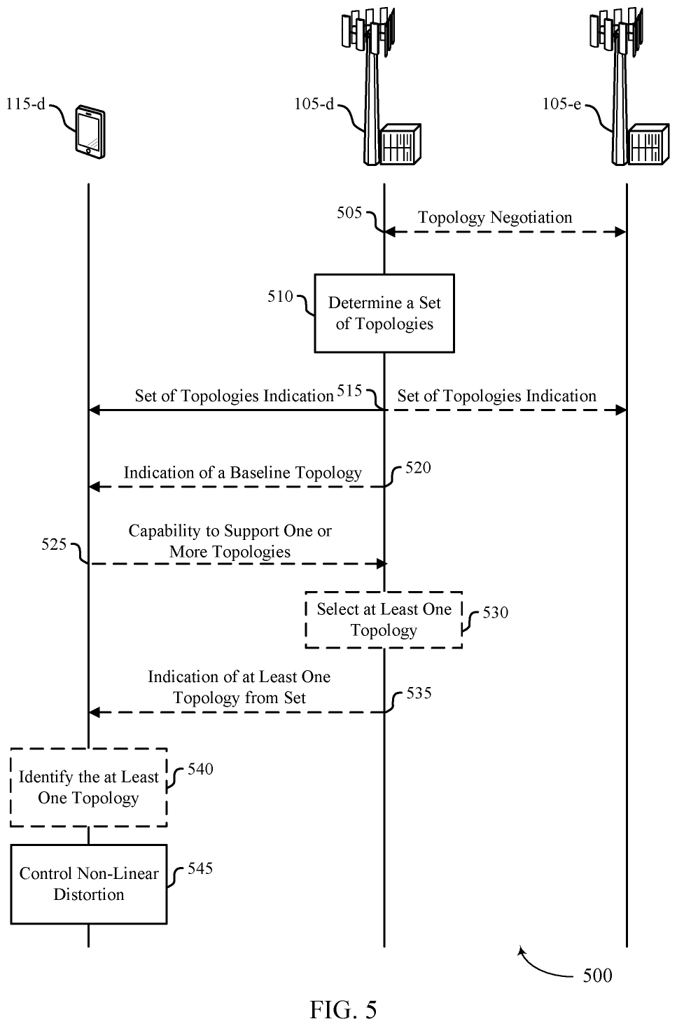

FIG. 5 illustrates an example of a process flow 500 that supports techniques for managing non-linear distortions in accordance with one or more aspects of the present disclosure. In some examples, the process flow 500 may implement or be implemented by aspects of the wireless communications system 100 and the wireless communications system 200 as described with reference to FIGS. 1 and 2, respectively. For example, the process flow 500 may be implemented by a network entity 105 c, a network entity 105 d, and a UE 115-d, which may be examples of a network entity 105 and a UE 115 as described with reference to FIGS. 1 and 2. The process flow 500 may be implemented by the network entity 105-d, the network entity 105-e, and the UE 115-d to exchange signaling to promote power saving at the UE 115-d and reliable communications between one or more of the network entity 105-d, the network entity 105-e, and the UE 115-d. In the following description of the process flow 500, the operations between the network entity 105-d, the network entity 105-e, and the UE 115-d may be transmitted in a different order than the example order shown, or the operations performed by the network entity 105-d, the network entity 105-e, and the UE 115-d may be performed in different orders or at different times. Some operations may also be omitted from the process flow 500, and other operations may be added to the process flow 500.

At 505, optionally, the network entity 105-d and the network entity 105-e may perform one more operations, in which the network entity 105-d and the network entity 105-e exchange control signaling to negotiate a topology. In some examples, the one or more operations may include the network entity 105-d or the network entity 105-e, or both, recommending a topology for wireless communication, selecting a topology for wireless communication, assigning a topology for wireless communication, accepting a topology for wireless communication, declining a topology for wireless communication, or any combination thereof. For example, the network entity 105-d may transmit (e.g., output), and the network entity 105-e may receive (e.g., obtain), control signaling carrying information, such as a topology identifier (e.g., a topology description), a topology recommendation, a feedback associated with a recommended topology, among other examples. Similarly, the network entity 105-e may transmit (e.g., output), and the network entity 105-d may receive (e.g., obtain), control signaling carrying information, such as a topology identifier (e.g., a topology description), a topology recommendation, a feedback associated with a recommended topology, among other examples. The network entity 105-d and the network entity 105-e may communicate over a backhaul interface (e.g., an Xn interface). As such, the exchange of signaling between the network entity 105-d and the network entity 105-e related to negotiating a topology may occur over the backhaul interface.

At 510, the network entity 105-d may determine a set of topologies associated with non-linear distortion characteristics of a wireless communication at the network entity 105-e or the UE 115-d, or both. A single waveform may have different distortion characteristics on different frequencies. Each of one or more topologies of set of topologies may include a frequency spectrum mask for the wireless communication. The wireless communication may be associated with a waveform at a frequency of a radio frequency spectrum band. The frequency spectrum mask may support interference mitigation at a different frequency associated with the waveform. In other words, each of one or more topologies of set of topologies may concentrate non-linear distortion at a respective frequency, which may mitigate interference at another respective frequency.

In some examples, each of the one or more topologies of the set of topologies may be associated with a set of parameters, which may define a respective frequency location, a resolution, a power ratio value (e.g., a dBc value) for a respective frequency location, a signal strength value (e.g., a dBm value when dBc values are insufficient) for a respective frequency location, an EVM value (e.g., in dB), among other examples. Additionally, the network entity 105-d may determine a duration in which one or more topologies from the set of topologies are valid (e.g., effective, enabled). For example, the network entity 105-d may indicate that a respective topology is effective over a set of transmission time intervals, including sub-slots, slots, subframes, frames, and the like. In some examples, the network entity 105-d may determine a beginning transmission time interval (e.g., a beginning slot) for a topology. In some cases, a topology may be valid indefinitely. For example, the network entity 105-e or the UE 115-d, or both, may enable a topology for the wireless communication until the network entity 105-d signals (e.g., via a DCI, a MAC-CE, or the like) to disable the topology or switch to another topology (e.g., a baseline topology).

At 515, the network entity 105-d may transmit (e.g., output), and the network entity 105-e or the UE 115-d, or both, may receive (e.g., obtain), control signaling indicating the set of topologies. The control signaling may be an RRC message, a DCI, a MAC-CE, or the like. In some examples, the network entity 105-e or the UE 115-d, or both may identify each of one or more topologies of the set of topologies based one each respective index associated with each of the one or more topologies. For example, the network entity 105-e or the UE 115-d, or both may identify a first topology of the set of topologies based on a first index, a second topology of the set of topologies based on a second index, and so on. In some example, each respective index associated with each of the one or more topologies may map to a data structure (e.g., table) that defines each of the one or more topologies. In other words, each respective index may map to a row in a table that corresponds to a respective topology of the set of topologies.

At 520, optionally, the network entity 105-d may transmit (e.g., output), and the UE 115-d may receive (e.g., obtain), control signaling indicating a baseline topology. The control signaling may be an RRC message, a DCI, a MAC-CE, or the like. In some examples, a zero index may correspond to the baseline topology (e.g., a default topology). The UE 115-d may then map the zero index to a row in a table that corresponds to the baseline topology. A baseline topology may be an example of a default topology that the UE 115-d is to use absent other considerations.

At 525, optionally, the UE 115-d may transmit (e.g., output), and the network entity 105-d may receive (e.g., obtain), control signaling indicating a capability of the UE 115-d to support one or more topologies of the set of topologies associated with the non-linear distortion characteristic of the wireless communication. The control signaling may include a MAC-CE or UCI, or the like. In some examples, when the UE 115-d is experiencing self-interference, the UE 115-d may transmit (e.g., output), and the network entity 105-d may receive (e.g., obtain), interference information. In some examples, the UE 115-d may recommend a topology irrespective of the set of topologies to the network entity 105-d. In some cases, when the UE 115-d supports sidelink communication with another UE 115, the UE 115-d may indicate a preferred characteristic associated with one or more topologies from the set of topologies.

At 530, optionally, the network entity 105-d may select at least one topology for the UE 115-d to use for the wireless communication. The network entity 105-d may select the at least one topology for the UE 115-d based on timing information, network load information, radio access technology information, or any combination thereof. Additionally, the network entity 105-d may evaluate previous topology negotiations, capability indications, or alternative topologies indicated by the UE 115-d when select the at least one topology for the UE 115-d.

At 535, optionally, the network entity 105-d may transmit (e.g., output), and the UE 115-d may receive (e.g., obtain), an indication of the at least one selected topology. The indication may include a respective index associated with the at least one selected topology. Additionally, the indication may indicate a beginning time (e.g., a beginning slot) for when the at least one selected topology is enabled and a duration (e.g., in number of slots) for the at least one selected topology to remain enabled. At 540, optionally, the UE 115-d may identify the at least one selected topology by the network entity 105-d. In some cases, the at least one selected topology may be associated with sidelink communications. At 545, the UE 115-d may control the non-linear distortion characteristics for the wireless communication according to the at least one selected topology.

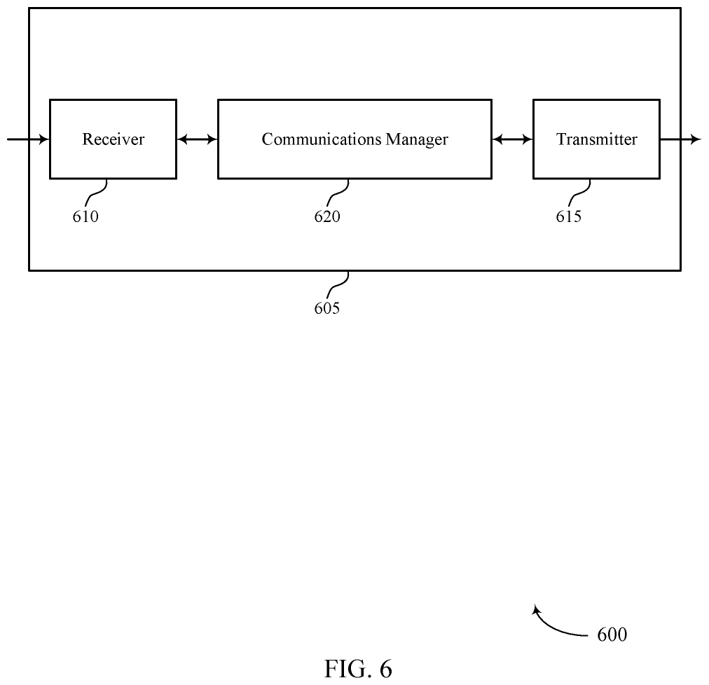

FIG. 6 shows a block diagram 600 of a device 605 that supports techniques for managing non-linear distortions in accordance with one or more aspects of the present disclosure. The device 605 may be an example of aspects of a network entity 105 as described herein. The device 605 may include a receiver 610, a transmitter 615, and a communications manager 620. The device 605 may also include a processor. Each of these components may be in communication with one another (e.g., via one or more buses).

The receiver 610 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 605. In some examples, the receiver 610 may support obtaining information by receiving signals via one or more antennas. Additionally, or alternatively, the receiver 610 may support obtaining information by receiving signals via one or more wired (e.g., electrical, fiber optic) interfaces, wireless interfaces, or any combination thereof.

The transmitter 615 may provide a means for outputting (e.g., transmitting, providing, conveying, sending) information generated by other components of the device 605. For example, the transmitter 615 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 615 may support outputting information by transmitting signals via one or more antennas. Additionally, or alternatively, the transmitter 615 may support outputting information by transmitting signals via one or more wired (e.g., electrical, fiber optic) interfaces, wireless interfaces, or any combination thereof. In some examples, the transmitter 615 and the receiver 610 may be co-located in a transceiver, which may include or be coupled with a modem.

The communications manager 620, the receiver 610, the transmitter 615, or various combinations thereof or various components thereof may be examples of means for performing various aspects of techniques for managing non-linear distortions as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at the device 605 (e.g., a network entity 105) in accordance with examples as disclosed herein. A single waveform may have different distortion characteristics on different frequencies. The communications manager 620 may be configured as or otherwise support a means for determining a set of topologies associated with a non-linear distortion characteristic of a wireless communication at a set of devices, each of one or more topologies of the set of topologies including a frequency spectrum mask for the wireless communication, the wireless communication including a waveform at a first frequency, the frequency spectrum mask associated with the non-linear distortion characteristic of the waveform at the first frequency for interference mitigation at a second frequency different than the first frequency. The communications manager 620 may be configured as or otherwise support a means for transmitting first control signaling indicating the set of topologies associated with the non-linear distortion characteristic of the waveform.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for more efficient utilization of time and frequency resources for wireless communication with the set of devices.

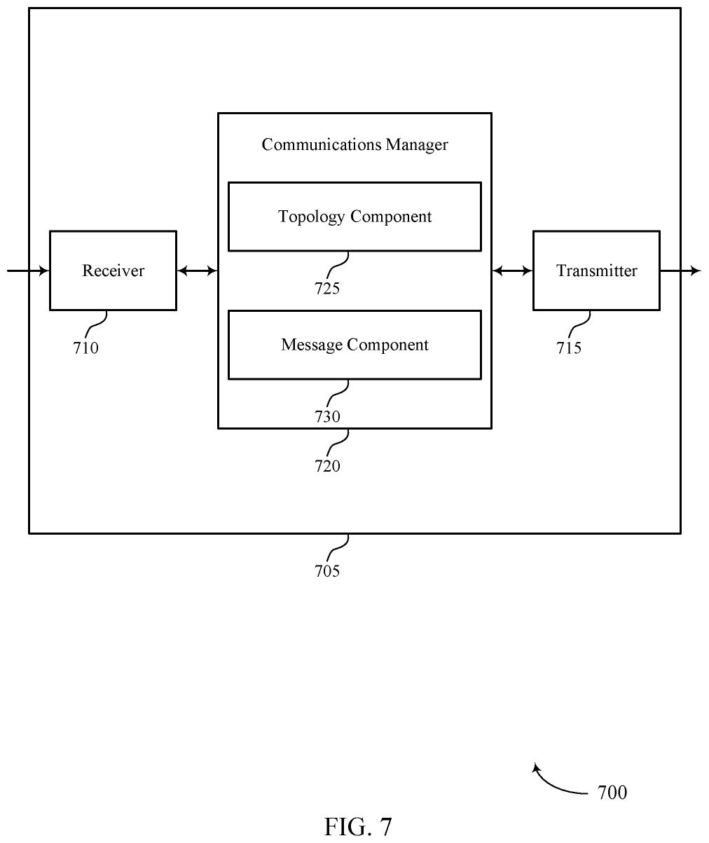

FIG. 7 shows a block diagram 700 of a device 705 that supports techniques for managing non-linear distortions in accordance with one or more aspects of the present disclosure. The device 705 may be an example of aspects of a device 605 or a network entity 105 as described herein. The device 705 may include a receiver 710, a transmitter 715, and a communications manager 720. The device 705 may also include a processor. Each of these components may be in communication with one another (e.g., via one or more buses).

The receiver 710 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 705. In some examples, the receiver 710 may support obtaining information by receiving signals via one or more antennas. Additionally, or alternatively, the receiver 710 may support obtaining information by receiving signals via one or more wired (e.g., electrical, fiber optic) interfaces, wireless interfaces, or any combination thereof.

The transmitter 715 may provide a means for outputting (e.g., transmitting, providing, conveying, sending) information generated by other components of the device 705. For example, the transmitter 715 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 715 may support outputting information by transmitting signals via one or more antennas. Additionally, or alternatively, the transmitter 715 may support outputting information by transmitting signals via one or more wired (e.g., electrical, fiber optic) interfaces, wireless interfaces, or any combination thereof. In some examples, the transmitter 715 and the receiver 710 may be co-located in a transceiver, which may include or be coupled with a modem.

The device 705, or various components thereof, may be an example of means for performing various aspects of techniques for managing non-linear distortions as described herein. For example, the communications manager 720 may include a topology component 725 a message component 730, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at the device 705 (e.g., a network entity 105) in accordance with examples as disclosed herein. A single waveform may have different distortion characteristics on different frequencies. The topology component 725 may be configured as or otherwise support a means for determining a set of topologies associated with a non-linear distortion characteristic of a wireless communication at a set of devices, each of one or more topologies of the set of topologies including a frequency spectrum mask for the wireless communication, the wireless communication including a waveform at a first frequency, the frequency spectrum mask associated with the non-linear distortion characteristic of the waveform at the first frequency for interference mitigation at a second frequency different than the first frequency. The message component 730 may be configured as or otherwise support a means for transmitting first control signaling indicating the set of topologies associated with the non-linear distortion characteristic of the waveform.

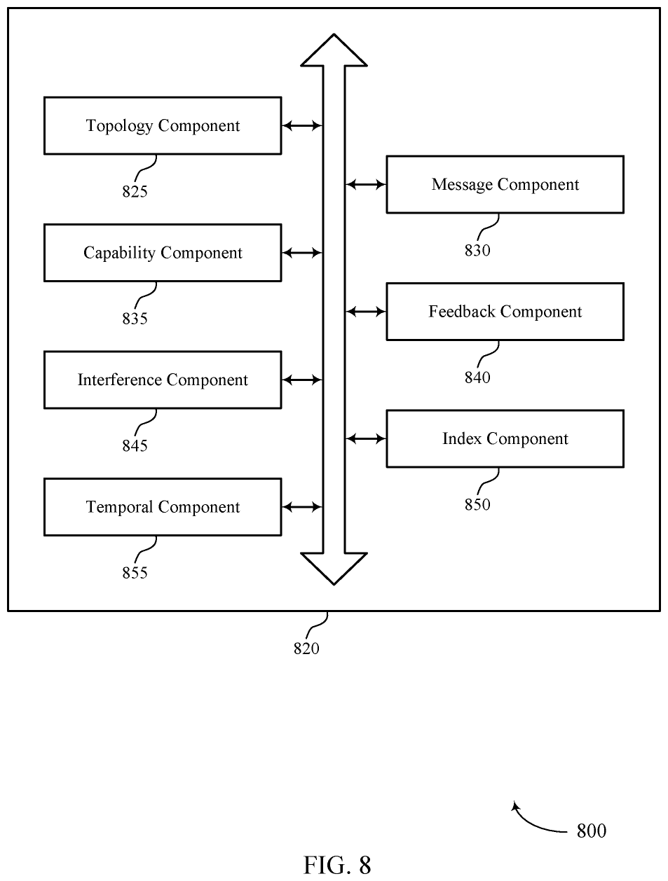

FIG. 8 shows a block diagram 800 of a communications manager 820 that supports techniques for managing non-linear distortions in accordance with one or more aspects of the present disclosure. The communications manager 820 may be an example of aspects of a communications manager 620, a communications manager 720, or both, as described herein. The communications manager 820, or various components thereof, may be an example of means for performing various aspects of techniques for managing non-linear distortions as described herein. For example, the communications manager 820 may include a topology component 825, a message component 830, a capability component 835, a feedback component 840, an interference component 845, an index component 850, a temporal component 855, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 820 may support wireless communication at a network entity in accordance with examples as disclosed herein. A single waveform may have different distortion characteristics on different frequencies. The topology component 825 may be configured as or otherwise support a means for determining a set of topologies associated with a non-linear distortion characteristic of a wireless communication at a set of devices, each of one or more topologies of the set of topologies including a frequency spectrum mask for the wireless communication, the wireless communication including a waveform at a first frequency, the frequency spectrum mask associated with the non-linear distortion characteristic of the waveform at the first frequency for interference mitigation at a second frequency different than the first frequency. The message component 830 may be configured as or otherwise support a means for transmitting first control signaling indicating the set of topologies associated with the non-linear distortion characteristic of the waveform.

In some examples, the capability component 835 may be configured as or otherwise support a means for receiving second control signaling indicating a capability to support one or more topologies of the set of topologies associated with the non-linear distortion characteristic of the wireless communication based on the transmitted first control signaling. In some examples, the second control signaling includes an RRC message or a MAC-CE.

In some examples, the topology component 825 may be configured as or otherwise support a means for selecting at least one topology of the set of topologies for use by the set of devices for the wireless communication, based on timing information, network load information, or radio access technology information, or any combination thereof. In some examples, the capability component 835 may be configured as or otherwise support a means for transmitting second control signaling indicating the selected at least one topology of the set of topologies. In some examples, the second control signaling includes an RRC message or a MAC-CE.

In some examples, the index component 850 may be configured as or otherwise support a means for identifying an index value associated with the selected at least one topology of the set of topologies. In some examples, the second control signaling includes an indication of the index value associated with the selected at least one topology of the set of topologies. In some examples, the temporal component 855 may be configured as or otherwise support a means for determining a duration including a set of slots in which the selected at least one topology of the set of topologies is valid. In some examples, the second control signaling includes a first indication of the duration including the set of slots in which the selected at least one topology of the set of topologies is valid. In some examples, the temporal component 855 may be configured as or otherwise support a means for determining a beginning slot of the set of slots in which the selected at least one topology of the set of topologies is valid. In some examples, the second control signaling includes a second indication of the beginning slot of the set of slots in which the selected at least one topology of the set of topologies is valid.

In some examples, to support transmitting the first control signaling, the message component 830 may be configured as or otherwise support a means for transmitting an RRC message or a MAC-CE, or both, indicating the set of topologies associated with the non-linear distortion characteristic of the wireless communication. In some examples, at least one topology of the set of topologies includes a baseline topology associated with the non-linear distortion characteristic of the wireless communication, the baseline topology corresponding to a default topology. In some examples, the message component 830 may be configured as or otherwise support a means for broadcasting second control signaling indicating the baseline topology associated with the non-linear distortion characteristic of the wireless communication. In some examples, the second control signaling includes a broadcast message including a DCI or MAC-CE. In some examples, the index component 850 may be configured as or otherwise support a means for identifying an index value associated with the baseline topology associated with the non-linear distortion characteristic of the wireless communication. In some examples, the second control signaling includes an indication of the index value associated with the baseline topology.

In some examples, the topology component 825 may be configured as or otherwise support a means for receiving second control signaling indicating a preferred set of topologies for a second network entity based on the transmitted first control signaling. In some examples, the feedback component 840 may be configured as or otherwise support a means for transmitting third control signaling indicating feedback for the preferred set of topologies, the feedback indicating an acknowledgment or a negative acknowledgment. In some examples, receiving the second control signaling, transmitting the third control signaling, or both, occur via a backhaul interface.

In some examples, the interference component 845 may be configured as or otherwise support a means for receiving second control signaling indicating interference information from at least one device of the set of devices based on the transmitted first control signaling. In some examples, the message component 830 may be configured as or otherwise support a means for transmitting the first control signaling indicating the set of topologies is based on the received second control signaling indicating the interference information.

In some examples, the topology component 825 may be configured as or otherwise support a means for receiving second control signaling from at least one device of the set of devices indicating a preferred topology of the set of topologies or at least one topology different from the set of topologies based on the transmitted first control signaling. In some examples, the message component 830 may be configured as or otherwise support a means for where the second control signaling including an RRC message, a MAC-CE, UCI, or any combination thereof.

In some examples, the topology component 825 may be configured as or otherwise support a means for receiving, based on the transmitted first control signaling, second control signaling from at least one device of the set of devices indicating a characteristic associated with at least one topology of the set of topologies used by the at least one device for sidelink communications.

In some examples, each of one or more topologies of the set of topologies includes a frequency location value associated with the wireless communication, a resolution value associated with the wireless communication, a power ratio value associated with the wireless communication, a signal strength value associated with the wireless communication, or an EVM value associated with the wireless communication, or any combination thereof.

In some examples, the set of devices includes a UE, a base station, an IAB node, or any combination thereof.

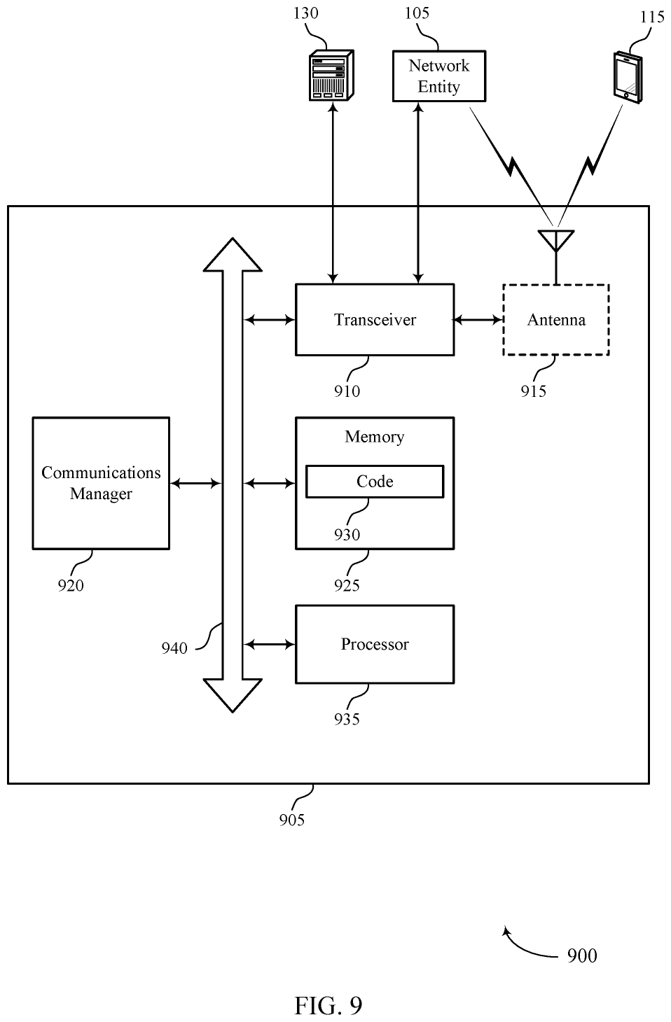

FIG. 9 shows a diagram of a system 900 including a device 905 that supports techniques for managing non-linear distortions in accordance with one or more aspects of the present disclosure. The device 905 may be an example of or include the components of a device 605, a device 705, or a network entity 105 as described herein. The device 905 may communicate with one or more network entities 105, one or more UEs 115, or any combination thereof, which may include communications over one or more wired interfaces, over one or more wireless interfaces, or any combination thereof. The device 905 may include components that support outputting and obtaining communications, such as a communications manager 920, a transceiver 910, an antenna 915, a memory 925, code 930, and a processor 935. These components may be in electronic communication or otherwise coupled (e.g., operatively, communicatively, functionally, electronically, electrically) via one or more buses (e.g., a bus 940).

The transceiver 910 may support bi-directional communications via wired links, wireless links, or both as described herein. In some examples, the transceiver 910 may include a wired transceiver and may communicate bi-directionally with another wired transceiver. Additionally, or alternatively, in some examples, the transceiver 910 may include a wireless transceiver and may communicate bi-directionally with another wireless transceiver. In some examples, the device 905 may include one or more antennas 915, which may be capable of transmitting or receiving wireless transmissions (e.g., concurrently). The transceiver 910 may also include a modem to modulate signals, to provide the modulated signals for transmission (e.g., by one or more antennas 915, by a wired transmitter), to receive modulated signals (e.g., from one or more antennas 915, from a wired receiver), and to demodulate signals. The transceiver 910, or the transceiver 910 and one or more antennas 915 or wired interfaces, where applicable, may be an example of a transmitter 615, a transmitter 715, a receiver 610, a receiver 710, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 925 may include RAM and ROM. The memory 925 may store computer-readable, computer-executable code 930 including instructions that, when executed by the processor 935, cause the device 905 to perform various functions described herein. The code 930 may be stored in a non-transitory computer-readable medium such as system memory or another type of memory. In some cases, the code 930 may not be directly executable by the processor 935 but may cause a computer (e.g., when compiled and executed) to perform functions described herein. In some cases, the memory 925 may contain, among other things, a BIOS which may control basic hardware or software operation such as the interaction with peripheral components or devices.

The processor 935 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 935 may be configured to operate a memory array using a memory controller. In some other cases, a memory controller may be integrated into the processor 935. The processor 935 may be configured to execute computer-readable instructions stored in a memory (e.g., the memory 925) to cause the device 905 to perform various functions (e.g., functions or tasks supporting techniques for managing non-linear distortions). For example, the device 905 or a component of the device 905 may include a processor 935 and memory 925 coupled with the processor 935, the processor 935 and memory 925 configured to perform various functions described herein. The processor 935 may be an example of a cloud-computing platform (e.g., one or more physical nodes and supporting software such as operating systems, virtual machines, or container instances) that may host the functions (e.g., by executing code 930) to perform the functions of the device 905.

In some examples, a bus 940 may support communications of (e.g., within) a protocol layer of a protocol stack. In some examples, a bus 940 may support communications associated with a logical channel of a protocol stack (e.g., between protocol layers of a protocol stack), which may include communications performed within a component of the device 905, or between different components of the device 905 that may be co-located or located in different locations (e.g., where the device 905 may refer to a system in which one or more of the communications manager 920, the transceiver 910, the memory 925, the code 930, and the processor 935 may be located in one of the different components or divided between different components).

In some examples, the communications manager 920 may manage aspects of communications with a core network 130 (e.g., via one or more wired or wireless backhaul links). For example, the communications manager 920 may manage the transfer of data communications for client devices, such as one or more UEs 115. In some examples, the communications manager 920 may manage communications with other network entities 105 and may include a controller or scheduler for controlling communications with UEs 115 in cooperation with other network entities 105. In some examples, the communications manager 920 may support an X2 interface within an LTE/LTE-A wireless communications network technology to provide communication between network entities 105.

The communications manager 920 may support wireless communication at the device 905 (e.g., a network entity 105) in accordance with examples as disclosed herein. A single waveform may have different distortion characteristics on different frequencies. The communications manager 920 may be configured as or otherwise support a means for determining a set of topologies associated with a non-linear distortion characteristic of a wireless communication at a set of devices, each of one or more topologies of the set of topologies including a frequency spectrum mask for the wireless communication, the wireless communication including a waveform at a first frequency, the frequency spectrum mask associated with the non-linear distortion characteristic of the waveform at the first frequency for interference mitigation at a second frequency different than the first frequency. The communications manager 920 may be configured as or otherwise support a means for transmitting first control signaling indicating the set of topologies associated with the non-linear distortion characteristic of the waveform.

By including or configuring the communications manager 920 in accordance with examples as described herein, the device 905 may support techniques for increased reliability and reduced latency for wireless communication with the set of devices.

In some examples, the communications manager 920 may be configured to perform various operations (e.g., receiving, obtaining, monitoring, outputting, transmitting) using or otherwise in cooperation with the transceiver 910, the one or more antennas 915 (e.g., where applicable), or any combination thereof. Although the communications manager 920 is illustrated as a separate component, in some examples, one or more functions described with reference to the communications manager 920 may be supported by or performed by the processor 935, the memory 925, the code 930, the transceiver 910, or any combination thereof. For example, the code 930 may include instructions executable by the processor 935 to cause the device 905 to perform various aspects of techniques for managing non-linear distortions as described herein, or the processor 935 and the memory 925 may be otherwise configured to perform or support such operations.

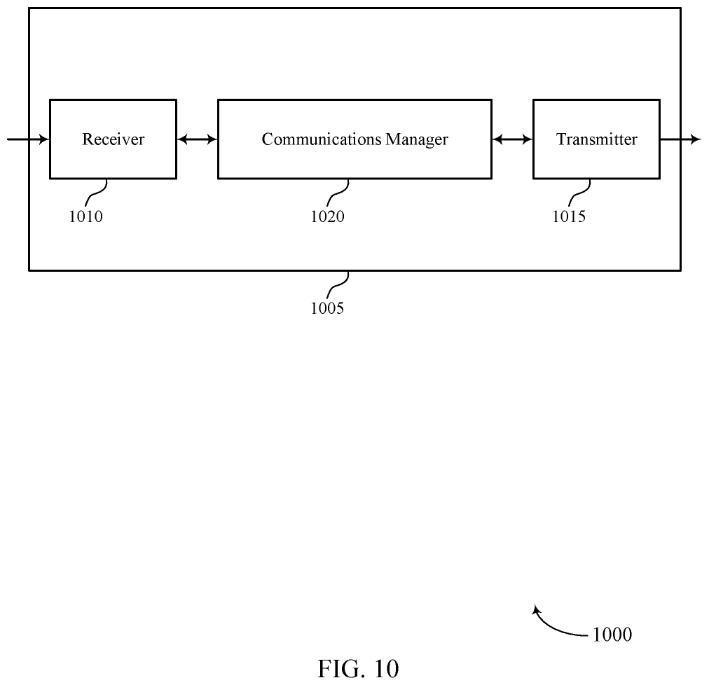

FIG. 10 shows a block diagram 1000 of a device 1005 that supports techniques for managing non-linear distortions in accordance with one or more aspects of the present disclosure. The device 1005 may be an example of aspects of a network entity 105, a UE 115, a base station 140 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to techniques for managing non-linear distortions). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to techniques for managing non-linear distortions). In some examples, the transmitter 1015 may be co-located with a receiver 1010 in a transceiver module. The transmitter 1015 may utilize a single antenna or a set of multiple antennas.

The communications manager 1020, the receiver 1010, the transmitter 1015, or various combinations thereof or various components thereof may be examples of means for performing various aspects of techniques for managing non-linear distortions as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a device 1005 (e.g., a UE 115, a base station 140, an IAB node, among other examples) in accordance with examples as disclosed herein. A single waveform may have different distortion characteristics on different frequencies. The communications manager 1020 may be configured as or otherwise support a means for receiving, from a network entity, first control signaling indicating a set of topologies associated with a non-linear distortion characteristic of the wireless communication at the device, each of one or more topologies of the set of topologies including a frequency spectrum mask for the wireless communication, the wireless communication including a waveform at a first frequency, the frequency spectrum mask associated with the non-linear distortion characteristic of the waveform at the first frequency for interference mitigation at a second frequency different from the first frequency. The communications manager 1020 may be configured as or otherwise support a means for controlling the non-linear distortion characteristic associated with the wireless communication based on the received first control signaling indicating the set of topologies.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for reduced power consumption.

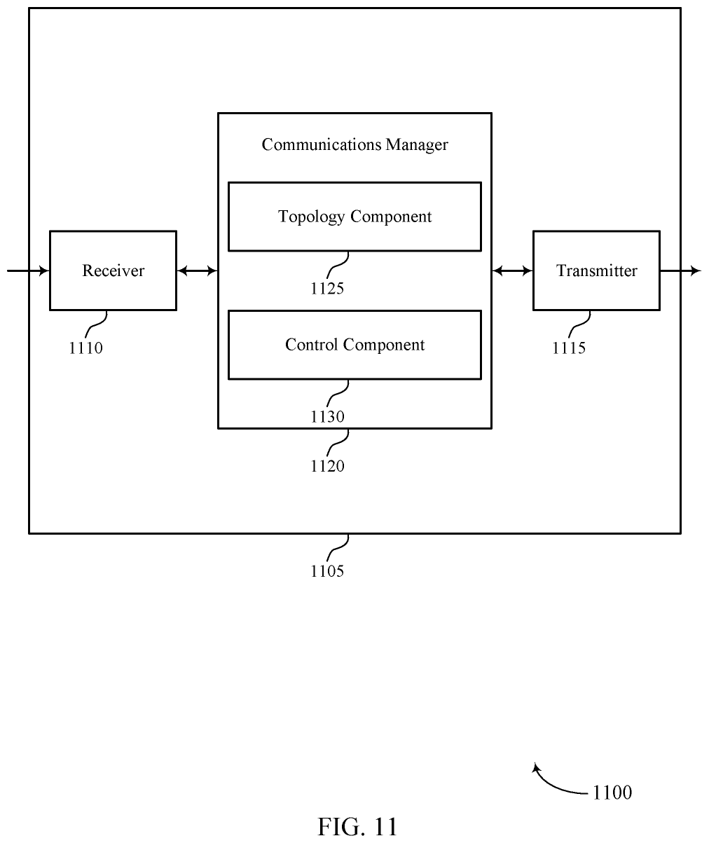

FIG. 11 shows a block diagram 1100 of a device 1105 that supports techniques for managing non-linear distortions in accordance with one or more aspects of the present disclosure. The device 1105 may be an example of aspects of a device 1005 or a network entity 105, a UE 115, a base station 140 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to techniques for managing non-linear distortions). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to techniques for managing non-linear distortions). In some examples, the transmitter 1115 may be co-located with a receiver 1110 in a transceiver module. The transmitter 1115 may utilize a single antenna or a set of multiple antennas.

The device 1105, or various components thereof, may be an example of means for performing various aspects of techniques for managing non-linear distortions as described herein. For example, the communications manager 1120 may include a topology component 1125 a control component 1130, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a device 1105 (e.g., a UE 115, a base station 140, an IAB node, among other examples) in accordance with examples as disclosed herein. A single waveform may have different distortion characteristics on different frequencies. The topology component 1125 may be configured as or otherwise support a means for receiving, from a network entity, first control signaling indicating a set of topologies associated with a non-linear distortion characteristic of the wireless communication at the device, each of one or more topologies of the set of topologies including a frequency spectrum mask for the wireless communication, the wireless communication including a waveform at a first frequency, the frequency spectrum mask associated with the non-linear distortion characteristic of the waveform at the first frequency for interference mitigation at a second frequency different from the first frequency. The control component 1130 may be configured as or otherwise support a means for controlling the non-linear distortion characteristic associated with the wireless communication based on the received first control signaling indicating the set of topologies.

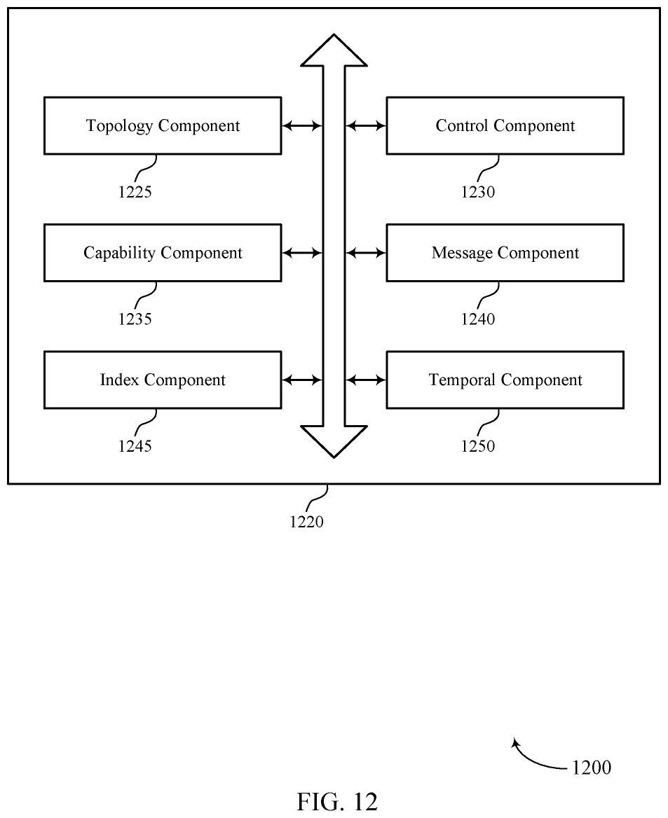

FIG. 12 shows a block diagram 1200 of a communications manager 1220 that supports techniques for managing non-linear distortions in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of techniques for managing non-linear distortions as described herein. For example, the communications manager 1220 may include a topology component 1225, a control component 1230, a capability component 1235, a message component 1240, an index component 1245, a temporal component 1250, or any combination thereof. Each of these components may communicate, directly or indirectly, with one another (e.g., via one or more buses).

The communications manager 1220 may support wireless communication at a device (e.g., a network entity 105, a UE 115, a base station 140 as described herein) in accordance with examples as disclosed herein. A single waveform may have different distortion characteristics on different frequencies. The topology component 1225 may be configured as or otherwise support a means for receiving, from a network entity, first control signaling indicating a set of topologies associated with a non-linear distortion characteristic of the wireless communication at the device, each of one or more topologies of the set of topologies including a frequency spectrum mask for the wireless communication, the wireless communication including a waveform at a first frequency, the frequency spectrum mask associated with the non-linear distortion characteristic of the waveform at the first frequency for interference mitigation at a second frequency different from the first frequency. The control component 1230 may be configured as or otherwise support a means for controlling the non-linear distortion characteristic associated with the wireless communication based on the received first control signaling indicating the set of topologies.

In some examples, the capability component 1235 may be configured as or otherwise support a means for transmitting second control signaling indicating a capability to support one or more topologies of the set of topologies based on the received first control signaling. In some examples, the capability component 1235 may be configured as or otherwise support a means for where the second control signaling includes an RRC message or a MAC-CE. In some examples, the topology component 1225 may be configured as or otherwise support a means for receiving second control signaling indicating a selected at least one topology of the set of topologies, by the network entity, associated with the non-linear distortion characteristic of the wireless communication. In some examples, the capability component 1235 may be configured as or otherwise support a means for where the second control signaling includes an RRC message or a MAC-CE.

In some examples, the index component 1245 may be configured as or otherwise support a means for identifying the selected at least one topology of the set of topologies associated with the non-linear distortion characteristic of the wireless communication based on an indication of an index value, associated with the selected at least one topology of the set of topologies, received in the second control signaling. In some examples, the temporal component 1250 may be configured as or otherwise support a means for identifying a duration including a set of slots in which the selected at least one topology of the set of topologies is valid based on a first indication of the duration including the set of slots in which the selected at least one topology of the set of topologies is valid, received in the second control signaling. In some examples, the temporal component 1250 may be configured as or otherwise support a means for identifying a beginning slot of the set of slots in which the selected at least one topology of the set of topologies is valid based on a second indication of the beginning slot of the set of slots in which the selected at least one topology of the set of topologies is valid, received in the second control signaling.

In some examples, to support receiving the first control signaling, the message component 1240 may be configured as or otherwise support a means for receiving an RRC message or a MAC-CE, or both, indicating the set of topologies associated with the non-linear distortion characteristic of the wireless communication. In some examples, at least one topology of the set of topologies includes a baseline topology associated with the non-linear distortion characteristic of the wireless communication, the baseline topology corresponding to a default topology.

In some examples, the topology component 1225 may be configured as or otherwise support a means for receiving second control signaling indicating the baseline topology. In some examples, the message component 1240 may be configured as or otherwise support a means for where the second control signaling includes a broadcast message including a DCI or MAC-CE. In some examples, the topology component 1225 may be configured as or otherwise support a means for identifying the baseline topology associated with the non-linear distortion characteristic of the wireless communication based on an indication of an index value associated with the baseline topology received in the second control signaling. In some examples, the device includes a UE, a base station, an IAB node, or any combination thereof.

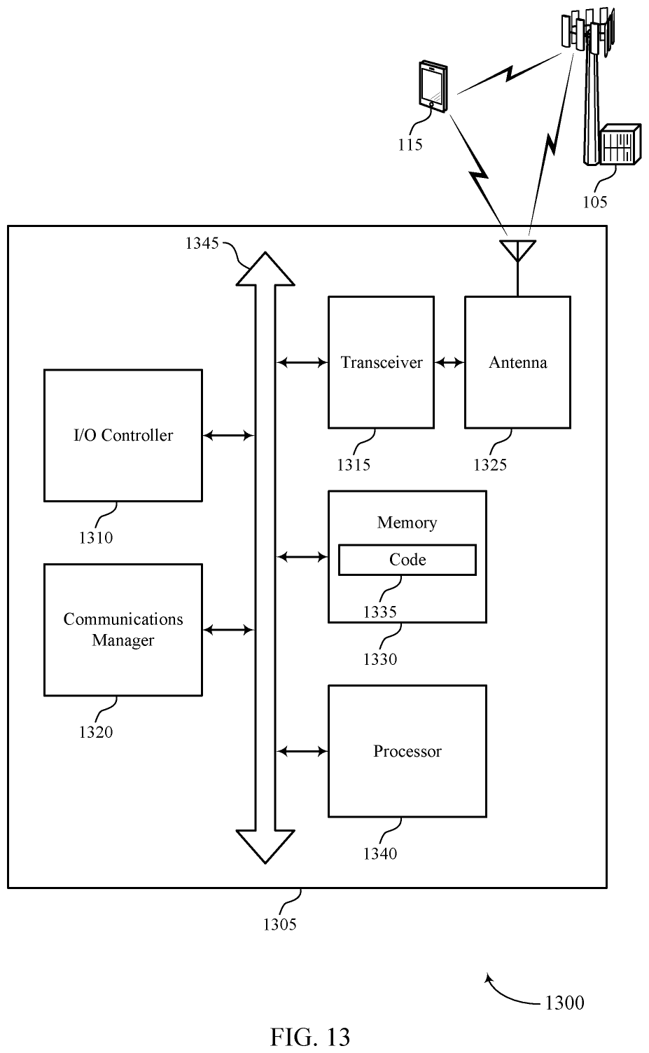

FIG. 13 shows a diagram of a system 1300 including a device 1305 that supports techniques for managing non-linear distortions in accordance with one or more aspects of the present disclosure. The device 1305 may be an example of or include the components of a device 1005, a device 1105, or a network entity 105, UE 115, or a base station 140 as described herein. The device 1305 may communicate (e.g., wirelessly) with one or more network entities 105, one or more UEs 115, or any combination thereof. The device 1305 may include components for bi-directional voice and data communications including components for transmitting and receiving communications, such as a communications manager 1320, an input/output (I/O) controller 1310, a transceiver 1315, an antenna 1325, a memory 1330, code 1335, and a processor 1340. These components may be in electronic communication or otherwise coupled (e.g., operatively, communicatively, functionally, electronically, electrically) via one or more buses (e.g., a bus 1345).

The I/O controller 1310 may manage input and output signals for the device 1305. The I/O controller 1310 may also manage peripherals not integrated into the device 1305. In some cases, the I/O controller 1310 may represent a physical connection or port to an external peripheral. In some cases, the I/O controller 1310 may utilize an operating system such as iOS®, ANDROID®, MS-DOS®, MS-WINDOWS®, OS/2®, UNIX®, LINUX®, or another known operating system. Additionally or alternatively, the I/O controller 1310 may represent or interact with a modem, a keyboard, a mouse, a touchscreen, or a similar device. In some cases, the I/O controller 1310 may be implemented as part of a processor, such as the processor 1340. In some cases, a user may interact with the device 1305 via the I/O controller 1310 or via hardware components controlled by the I/O controller 1310.

In some cases, the device 1305 may include a single antenna 1325. However, in some other cases, the device 1305 may have more than one antenna 1325, which may be capable of concurrently transmitting or receiving multiple wireless transmissions. The transceiver 1315 may communicate bi-directionally, via the one or more antennas 1325, wired, or wireless links as described herein. For example, the transceiver 1315 may represent a wireless transceiver and may communicate bi-directionally with another wireless transceiver. The transceiver 1315 may also include a modem to modulate the packets, to provide the modulated packets to one or more antennas 1325 for transmission, and to demodulate packets received from the one or more antennas 1325. The transceiver 1315, or the transceiver 1315 and one or more antennas 1325, may be an example of a transmitter 1015, a transmitter 1115, a receiver 1010, a receiver 1110, or any combination thereof or component thereof, as described herein.

The memory 1330 may include random access memory (RAM) and read-only memory (ROM). The memory 1330 may store computer-readable, computer-executable code 1335 including instructions that, when executed by the processor 1340, cause the device 1305 to perform various functions described herein. The code 1335 may be stored in a non-transitory computer-readable medium such as system memory or another type of memory. In some cases, the code 1335 may not be directly executable by the processor 1340 but may cause a computer (e.g., when compiled and executed) to perform functions described herein. In some cases, the memory 1330 may contain, among other things, a basic I/O system (BIOS) which may control basic hardware or software operation such as the interaction with peripheral components or devices.

The processor 1340 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1340 may be configured to operate a memory array using a memory controller. In some other cases, a memory controller may be integrated into the processor 1340. The processor 1340 may be configured to execute computer-readable instructions stored in a memory (e.g., the memory 1330) to cause the device 1305 to perform various functions (e.g., functions or tasks supporting techniques for managing non-linear distortions). For example, the device 1305 or a component of the device 1305 may include a processor 1340 and memory 1330 coupled with or to the processor 1340, the processor 1340 and memory 1330 configured to perform various functions described herein.

The communications manager 1320 may support wireless communication at a device 1305 (e.g., a network entity 105, a UE 115, a base station 140, among other examples) in accordance with examples as disclosed herein. A single waveform may have different distortion characteristics on different frequencies. For example, the communications manager 1320 may be configured as or otherwise support a means for receiving, from a network entity, first control signaling indicating a set of topologies associated with a non-linear distortion characteristic of the wireless communication at the device, each of one or more topologies of the set of topologies including a frequency spectrum mask for the wireless communication, the wireless communication including a waveform at a first frequency, the frequency spectrum mask associated with the non-linear distortion characteristic of the waveform at the first frequency for interference mitigation at a second frequency different from the first frequency. The communications manager 1320 may be configured as or otherwise support a means for controlling the non-linear distortion characteristic associated with the wireless communication based on the received first control signaling indicating the set of topologies.

By including or configuring the communications manager 1320 in accordance with examples as described herein, the device 1305 may support techniques for improved communication reliability, reduced latency, and reduced power consumption.

In some examples, the communications manager 1320 may be configured to perform various operations (e.g., receiving, monitoring, transmitting) using or otherwise in cooperation with the transceiver 1315, the one or more antennas 1325, or any combination thereof. Although the communications manager 1320 is illustrated as a separate component, in some examples, one or more functions described with reference to the communications manager 1320 may be supported by or performed by the processor 1340, the memory 1330, the code 1335, or any combination thereof. For example, the code 1335 may include instructions executable by the processor 1340 to cause the device 1305 to perform various aspects of techniques for managing non-linear distortions as described herein, or the processor 1340 and the memory 1330 may be otherwise configured to perform or support such operations.

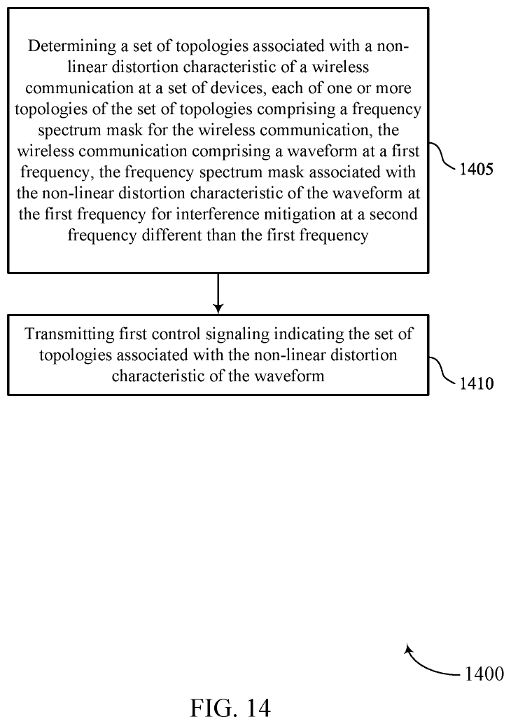

FIG. 14 shows a flowchart illustrating a method 1400 that supports techniques for managing non-linear distortions in accordance with one or more aspects of the present disclosure. The operations of the method 1400 may be implemented by a network entity or its components as described herein. For example, the operations of the method 1400 may be performed by a network entity as described with reference to FIGS. 1 through 9. In some examples, a network entity may execute a set of instructions to control the functional elements of the network entity to perform the described functions. Additionally, or alternatively, the network entity may perform aspects of the described functions using special-purpose hardware.

At 1405, the method may include determining a set of topologies associated with a non-linear distortion characteristic of a wireless communication at a set of devices, each of one or more topologies of the set of topologies including a frequency spectrum mask for the wireless communication, the wireless communication including a waveform at a first frequency, the frequency spectrum mask associated with the non-linear distortion characteristic of the waveform at the first frequency for interference mitigation at a second frequency different than the first frequency. The operations of 1405 may be performed in accordance with examples as disclosed herein. In some examples, aspects of the operations of 1405 may be performed by a topology component 825 as described with reference to FIG. 8.

At 1410, the method may include transmitting first control signaling indicating the set of topologies associated with the non-linear distortion characteristic of the waveform. The operations of 1410 may be performed in accordance with examples as disclosed herein. In some examples, aspects of the operations of 1410 may be performed by a message component 830 as described with reference to FIG. 8.

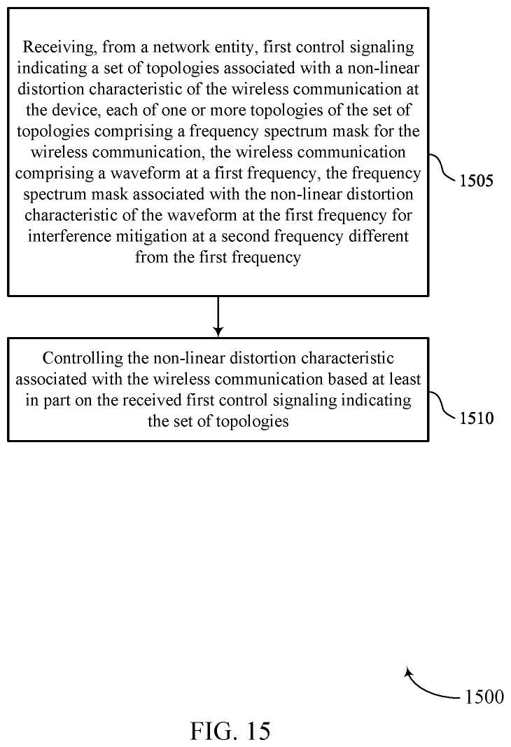

FIG. 15 shows a flowchart illustrating a method 1500 that supports techniques for managing non-linear distortions in accordance with one or more aspects of the present disclosure. The operations of the method 1500 may be implemented by a UE, a base station, a network entity, or its components as described herein. For example, the operations of the method 1500 may be performed by a UE 115 as described with reference to FIGS. 1 through 5 and 10 through 13. In some examples, a UE may execute a set of instructions to control the functional elements of the UE to perform the described functions. Additionally, or alternatively, the UE may perform aspects of the described functions using special-purpose hardware.

At 1505, the method may include receiving, from a network entity, first control signaling indicating a set of topologies associated with a non-linear distortion characteristic of the wireless communication at the device, each of one or more topologies of the set of topologies including a frequency spectrum mask for the wireless communication, the wireless communication including a waveform at a first frequency, the frequency spectrum mask associated with the non-linear distortion characteristic of the waveform at the first frequency for interference mitigation at a second frequency different from the first frequency. The operations of 1505 may be performed in accordance with examples as disclosed herein. In some examples, aspects of the operations of 1505 may be performed by a topology component 1225 as described with reference to FIG. 12.

At 1510, the method may include controlling the non-linear distortion characteristic associated with the wireless communication based at least in part on the received first control signaling indicating the set of topologies. The operations of 1510 may be performed in accordance with examples as disclosed herein. In some examples, aspects of the operations of 1510 may be performed by a control component 1230 as described with reference to FIG. 12.

It should be noted that the methods described herein describe possible implementations, and that the operations and the steps may be rearranged or otherwise modified and that other implementations are possible. Further, aspects from two or more of the methods may be combined.

The following provides an overview of aspects of the present disclosure:

Aspect 1: A method for wireless communication at a network entity, comprising: determining a set of topologies associated with a non-linear distortion characteristic of a wireless communication at a set of devices, each of one or more topologies of the set of topologies comprising a frequency spectrum mask for the wireless communication, the wireless communication comprising a waveform at a first frequency, the frequency spectrum mask associated with the non-linear distortion characteristic of the waveform at the first frequency for interference mitigation at a second frequency different than the first frequency: and transmitting first control signaling indicating the set of topologies associated with the non-linear distortion characteristic of the waveform.

Aspect 2: The method of aspect 1, further comprising: receiving second control signaling indicating a capability to support one or more topologies of the set of topologies associated with the non-linear distortion characteristic of the wireless communication based at least in part on the transmitted first control signaling, wherein the second control signaling comprises an RRC message or a MAC-CE.

Aspect 3: The method of any of aspects 1 through 2, further comprising: selecting at least one topology of the set of topologies for use by the set of devices for the wireless communication, based at least in part on timing information, network load information, or radio access technology information, or any combination thereof: and transmitting second control signaling indicating the selected at least one topology of the set of topologies, wherein the second control signaling comprises an RRC message or a MAC-CE.

Aspect 4: The method of aspect 3, further comprising: identifying an index value associated with the selected at least one topology of the set of topologies, wherein the second control signaling comprises an indication of the index value associated with the selected at least one topology of the set of topologies.

Aspect 5: The method of any of aspects 3 through 4, further comprising: determining a duration comprising a set of slots in which the selected at least one topology of the set of topologies is valid, wherein the second control signaling comprises a first indication of the duration comprising the set of slots in which the selected at least one topology of the set of topologies is valid.

Aspect 6: The method of aspect 5, further comprising: determining a beginning slot of the set of slots in which the selected at least one topology of the set of topologies is valid, wherein the second control signaling comprises a second indication of the beginning slot of the set of slots in which the selected at least one topology of the set of topologies is valid.

Aspect 7: The method of any of aspects 1 through 6, wherein transmitting the first control signaling comprises: transmitting an RRC message or a MAC-CE, or both, indicating the set of topologies associated with the non-linear distortion characteristic of the wireless communication.

Aspect 8: The method of any of aspects 1 through 7, wherein at least one topology of the set of topologies comprises a baseline topology associated with the non-linear distortion characteristic of the wireless communication, the baseline topology corresponding to a default topology.

Aspect 9: The method of aspect 8, further comprising: broadcasting second control signaling indicating the baseline topology associated with the non-linear distortion characteristic of the wireless communication, wherein the second control signaling includes a broadcast message comprising a DCI or MAC-CE.

Aspect 10: The method of aspect 9, further comprising: identifying an index value associated with the baseline topology associated with the non-linear distortion characteristic of the wireless communication, wherein the second control signaling comprises an indication of the index value associated with the baseline topology.

Aspect 11: The method of any of aspects 1 through 10, further comprising: receiving second control signaling indicating a preferred set of topologies for a second network entity based at least in part on the transmitted first control signaling: and transmitting third control signaling indicating feedback for the preferred set of topologies, the feedback indicating an acknowledgment or a negative acknowledgment.

Aspect 12: The method of aspect 11, wherein receiving the second control signaling, transmitting the third control signaling, or both, occur via a backhaul interface.

Aspect 13: The method of any of aspects 1 through 12, further comprising: receiving second control signaling indicating interference information from at least one device of the set of devices based at least in part on the transmitted first control signaling, wherein transmitting the first control signaling indicating the set of topologies is based at least in part on the received second control signaling indicating the interference information.

Aspect 14: The method of any of aspects 1 through 13, further comprising: receiving second control signaling from at least one device of the set of devices indicating a preferred topology of the set of topologies or at least one topology different from the set of topologies based at least in part on the transmitted first control signaling, wherein the second control signaling comprising an RRC message, a MAC-CE, UCI, or any combination thereof.

Aspect 15: The method of any of aspects 1 through 14, further comprising: receiving, based at least in part on the transmitted first control signaling, second control signaling from at least one device of the set of devices indicating a characteristic associated with at least one topology of the set of topologies used by the at least one device for sidelink communications.

Aspect 16: The method of any of aspects 1 through 15, wherein each of one or more topologies of the set of topologies comprises a frequency location value associated with the wireless communication, a resolution value associated with the wireless communication, a power ratio value associated with the wireless communication, a signal strength value associated with the wireless communication, or an error vector magnitude value associated with the wireless communication, or any combination thereof.

Aspect 17: The method of any of aspects 1 through 16, wherein the set of devices comprises a UE, a base station, an IAB node, or any combination thereof.

Aspect 18: A method for wireless communication at a device, comprising: receiving, from a network entity, first control signaling indicating a set of topologies associated with a non-linear distortion characteristic of the wireless communication at the device, each of one or more topologies of the set of topologies comprising a frequency spectrum mask for the wireless communication, the wireless communication comprising a waveform at a first frequency, the frequency spectrum mask associated with the non-linear distortion characteristic of the waveform at the first frequency for interference mitigation at a second frequency different from the first frequency: and controlling the non-linear distortion characteristic associated with the wireless communication based at least in part on the received first control signaling indicating the set of topologies.

Aspect 19: The method of aspect 18, further comprising: transmitting second control signaling indicating a capability to support one or more topologies of the set of topologies based at least in part on the received first control signaling, wherein the second control signaling comprises an RRC message or a MAC-CE.

Aspect 20: The method of any of aspects 18 through 19, further comprising: receiving second control signaling indicating a selected at least one topology of the set of topologies, by the network entity, associated with the non-linear distortion characteristic of the wireless communication, wherein the second control signaling comprises an RRC message or a MAC-CE.

Aspect 21: The method of aspect 20, further comprising: identifying the selected at least one topology of the set of topologies associated with the non-linear distortion characteristic of the wireless communication based at least in part on an indication of an index value, associated with the selected at least one topology of the set of topologies, received in the second control signaling.

Aspect 22: The method of any of aspects 20 through 21, further comprising: identifying a duration comprising a set of slots in which the selected at least one topology of the set of topologies is valid based at least in part on a first indication of the duration comprising the set of slots in which the selected at least one topology of the set of topologies is valid, received in the second control signaling.

Aspect 23: The method of aspect 22, further comprising: identifying a beginning slot of the set of slots in which the selected at least one topology of the set of topologies is valid based at least in part on a second indication of the beginning slot of the set of slots in which the selected at least one topology of the set of topologies is valid, received in the second control signaling.

Aspect 24: The method of any of aspects 18 through 23, wherein receiving the first control signaling comprises: receiving an RRC message or a MAC-CE, or both, indicating the set of topologies associated with the non-linear distortion characteristic of the wireless communication.

Aspect 25: The method of any of aspects 18 through 24, wherein at least one topology of the set of topologies comprises a baseline topology associated with the non-linear distortion characteristic of the wireless communication, the baseline topology corresponding to a default topology.

Aspect 26: The method of aspect 25, further comprising: receiving second control signaling indicating the baseline topology, wherein the second control signaling includes a broadcast message comprising a DCI or MAC-CE.

Aspect 27: The method of aspect 26, further comprising: identifying the baseline topology associated with the non-linear distortion characteristic of the wireless communication based at least in part on an indication of an index value associated with the baseline topology received in the second control signaling.

Aspect 28: The method of any of aspects 18 through 27, wherein the device comprises a UE, a base station, an IAB node, or any combination thereof.

Aspect 29: An apparatus for wireless communication at a network entity, comprising a processor: a memory coupled with the processor: wherein the memory comprises instructions executable by the processor to cause the apparatus to perform a method of any of aspects 1 through 17.

Aspect 30: An apparatus for wireless communication at a network entity, comprising at least one means for performing a method of any of aspects 1 through 17.

Aspect 31: A non-transitory computer-readable medium storing code for wireless communication at a network entity, the code comprising instructions executable by a processor to perform a method of any of aspects 1 through 17.

Aspect 32: An apparatus for wireless communication at a device, comprising a processor: memory coupled with the processor: wherein the memory comprises instructions executable by the processor to cause the apparatus perform a method of any of aspects 18 through 28.

Aspect 33: An apparatus for wireless communication at a device, comprising at least one means for performing a method of any of aspects 18 through 28.

Aspect 34: A non-transitory computer-readable medium storing code for wireless communication at a device, the code comprising instructions executable by a processor to perform a method of any of aspects 18 through 28.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database, or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a network entity, comprising:
determining a set of topologies associated with a non-linear distortion characteristic of a wireless communication at a set of devices, each of one or more topologies of the set of topologies comprising a frequency spectrum mask for the wireless communication, the wireless communication comprising a waveform at a first frequency, the frequency spectrum mask associated with the non-linear distortion characteristic of the waveform at the first frequency for interference mitigation at a second frequency different than the first frequency; and
transmitting first control signaling indicating the set of topologies associated with the non-linear distortion characteristic of the waveform.

2. The method of claim 1, further comprising:
receiving second control signaling indicating a capability to support one or more topologies of the set of topologies associated with the non-linear distortion characteristic of the wireless communication based at least in part on the transmitted first control signaling,
wherein the second control signaling comprises a radio resource control (RRC) message or a medium access control-control element (MAC-CE).

3. The method of claim 1, further comprising:
selecting at least one topology of the set of topologies for use by the set of devices for the wireless communication, based at least in part on timing information, network load information, or radio access technology information, or any combination thereof; and
transmitting second control signaling indicating the selected at least one topology of the set of topologies,
wherein the second control signaling comprises a radio resource control (RRC) message or a medium access control-control element (MAC-CE).

4. The method of claim 3, further comprising:
identifying an index value associated with the selected at least one topology of the set of topologies,
wherein the second control signaling comprises an indication of the index value associated with the selected at least one topology of the set of topologies.

5. The method of claim 3, further comprising:
determining a duration comprising a set of slots in which the selected at least one topology of the set of topologies is valid,
wherein the second control signaling comprises a first indication of the duration comprising the set of slots in which the selected at least one topology of the set of topologies is valid.

6. The method of claim 5, further comprising:
determining a beginning slot of the set of slots in which the selected at least one topology of the set of topologies is valid,
wherein the second control signaling comprises a second indication of the beginning slot of the set of slots in which the selected at least one topology of the set of topologies is valid.

7. The method of claim 1, wherein transmitting the first control signaling comprises:
transmitting a radio resource control (RRC) message or a medium access control-control element (MAC-CE), or both, indicating the set of topologies associated with the non-linear distortion characteristic of the wireless communication.

8. The method of claim 1, wherein at least one topology of the set of topologies comprises a baseline topology associated with the non-linear distortion characteristic of the wireless communication, the baseline topology corresponding to a default topology.

9. The method of claim 8, further comprising:
broadcasting second control signaling indicating the baseline topology associated with the non-linear distortion characteristic of the wireless communication,
wherein the second control signaling includes a broadcast message comprising a downlink control information (DCI) or medium access control-control element (MAC-CE).

10. The method of claim 9, further comprising:
identifying an index value associated with the baseline topology associated with the non-linear distortion characteristic of the wireless communication,
wherein the second control signaling comprises an indication of the index value associated with the baseline topology.

11. The method of claim 1, further comprising:
receiving second control signaling indicating a preferred set of topologies for a second network entity based at least in part on the transmitted first control signaling; and
transmitting third control signaling indicating feedback for the preferred set of topologies, the feedback indicating an acknowledgment or a negative acknowledgment.

12. The method of claim 11, wherein receiving the second control signaling, transmitting the third control signaling, or both, occur via a backhaul interface.

13. The method of claim 1, further comprising:
receiving second control signaling indicating interference information from at least one device of the set of devices based at least in part on the transmitted first control signaling,
wherein transmitting the first control signaling indicating the set of topologies is based at least in part on the received second control signaling indicating the interference information.

14. The method of claim 1, further comprising:
receiving second control signaling from at least one device of the set of devices indicating a preferred topology of the set of topologies or at least one topology different from the set of topologies based at least in part on the transmitted first control signaling,
wherein the second control signaling comprising a radio resource control (RRC) message, a medium access control-control element (MAC-CE), uplink control information (UCI), or any combination thereof.

15. The method of claim 1, further comprising:
receiving, based at least in part on the transmitted first control signaling, second control signaling from at least one device of the set of devices indicating a characteristic associated with at least one topology of the set of topologies used by the at least one device for sidelink communications.

16. The method of claim 1, wherein each of one or more topologies of the set of topologies comprises a frequency location value associated with the wireless communication. a resolution value associated with the wireless communication, a power ratio value associated with the wireless communication, a signal strength value associated with the wireless communication, or an error vector magnitude value associated with the wireless communication, or any combination thereof.

17. The method of claim 1, wherein the set of devices comprises a user equipment (UE), a base station, an integrated access and backhaul (IAB) node, or any combination thereof.

18. A method for wireless communication at a device, comprising:
receiving, from a network entity, first control signaling indicating a set of topologies associated with a non-linear distortion characteristic of the wireless communication at the device, each of one or more topologies of the set of topologies comprising a frequency spectrum mask for the wireless communication, the wireless communication comprising a waveform at a first frequency, the frequency spectrum mask associated with the non-linear distortion characteristic of the waveform at the first frequency for interference mitigation at a second frequency different from the first frequency; and
controlling the non-linear distortion characteristic associated with the wireless communication based at least in part on the received first control signaling indicating the set of topologies.

19. The method of claim 18, further comprising:
transmitting second control signaling indicating a capability to support one or more topologies of the set of topologies based at least in part on the received first control signaling,
wherein the second control signaling comprises a radio resource control (RRC) message or a medium access control-control element (MAC-CE).

20. The method of claim 18, further comprising:
receiving second control signaling indicating a selected at least one topology of the set of topologies, by the network entity, associated with the non-linear distortion characteristic of the wireless communication,
wherein the second control signaling comprises a radio resource control (RRC) message or a medium access control-control element (MAC-CE).

21. The method of claim 20, further comprising:
identifying the selected at least one topology of the set of topologies associated with the non-linear distortion characteristic of the wireless communication based at least in part on an indication of an index value, associated with the selected at least one topology of the set of topologies, received in the second control signaling.

22. The method of claim 20, further comprising:
identifying a duration comprising a set of slots in which the selected at least one topology of the set of topologies is valid based at least in part on a first indication of the duration comprising the set of slots in which the selected at least one topology of the set of topologies is valid, received in the second control signaling.

23. The method of claim 22, further comprising:
identifying a beginning slot of the set of slots in which the selected at least one topology of the set of topologies is valid based at least in part on a second indication of the beginning slot of the set of slots in which the selected at least one topology of the set of topologies is valid, received in the second control signaling.

24. The method of claim 18, wherein receiving the first control signaling comprises:
receiving a radio resource control (RRC) message or a medium access control-control element (MAC-CE), or both, indicating the set of topologies associated with the non-linear distortion characteristic of the wireless communication.

25. The method of claim 18, wherein at least one topology of the set of topologies comprises a baseline topology associated with the non-linear distortion characteristic of the wireless communication, the baseline topology corresponding to a default topology.

26. The method of claim 25, further comprising:
receiving second control signaling indicating the baseline topology,
wherein the second control signaling includes a broadcast message comprising a downlink control information (DCI) or medium access control-control element (MAC-CE).

27. The method of claim 26, further comprising:
identifying the baseline topology associated with the non-linear distortion characteristic of the wireless communication based at least in part on an indication of an index value associated with the baseline topology received in the second control signaling.

28. The method of claim 18, wherein the device comprises a user equipment (UE), a base station, an integrated access and backhaul (IAB) node, or any combination thereof.

29. An apparatus for wireless communication at a network entity, comprising:
a processor; and
a memory coupled with the processor: wherein the memory comprises instructions executable by the processor to cause the apparatus to:
determine a set of topologies associated with a non-linear distortion characteristic of a wireless communication at a set of devices, each of one or more topologies of the set of topologies comprising a frequency spectrum mask for the wireless communication, the wireless communication comprising a waveform at a first frequency, the frequency spectrum mask associated with the non-linear distortion characteristic of the waveform at the first frequency for interference mitigation at a second frequency different than the first frequency; and
transmit first control signaling indicating the set of topologies associated with the non-linear distortion characteristic of the waveform.

30. An apparatus for wireless communication at a device, comprising:
a processor; and
a memory coupled with the processor; wherein the memory comprises instructions executable by the processor to cause the apparatus to:
receive, from a network entity, first control signaling indicating a set of topologies associated with a non-linear distortion characteristic of the wireless communication at the device, each of one or more topologies of the set of topologies comprising a frequency spectrum mask for the wireless communication, the wireless communication comprising a waveform at a first frequency, the frequency spectrum mask associated with the non-linear distortion characteristic of the waveform at the first frequency for interference mitigation at a second frequency different from the first frequency; and
control the non-linear distortion characteristic associated with the wireless communication based at least in part on the received first control signaling indicating the set of topologies.
